(19) United States
(12) Patent Application Publication
(10) Pub. No.: US 2018/0036897 A1
(43) Pub. Date: Feb. 8, 2018

(54) SYSTEM AND METHOD FOR CUTTING BREAD LOAF INTO SANDWICHES

(71) Applicant: GIDRON INDUSTRIES LTD, Holon (IL)

(72) Inventors: Tal LEIZER, Shefayim (IL); Nathan GUTTENBERG, Ramat Gan (IL); Boris SHTRIMER, Petach Tiqwa (IL); Amichai C. YIFRACH, Kedumim (IL); Meir BARELI, Kiryat-Ata (IL)

(73) Assignee: GIDRON INDUSTRIES LTD

(21) Appl. No.: 15/225,895

(22) Filed: Aug. 2, 2016

(51) Int. Cl. B26D 5/00; B26D 7/32; B26D 7/28; A21C 15/00; B26D 7/08

(52) U.S. Cl. CPC B26D 5/005; A21C 15/00; B26D 7/086; B26D 7/28; B26D 7/32; B26D 2210/06; B26D 2007/327

(57) ABSTRACT

A system and method for cutting a bread loaf into sandwiches comprising two partially connected slices of bread with a pocket there between. The system and method comprise measuring the outline of the bread loaf and cutting a sandwich pocket as well as cutting a sandwich off the bread loaf, according to a predetermined sandwich width or per user's preferences.

### TECHNICAL FIELD

The present invention relates to a system and method for cutting a bread loaf into sandwiches, and more specifically to a system and method for cutting bread loaf into sandwiches comprising sandwich pockets.

### BACKGROUND

Sliced bread loaves are commonly found in any store that sells food, e.g., supermarkets, grocery stores, etc. A sliced bread loaf makes it easier for the customer to consume the bread without the need to cut it by himself. The customer may eat each slice on its own with or without a spread, or may make sandwiches out of two slices of bread, typically, two adjacent slices of bread, and may eat these two slices together after inserting any edible ingredient or after spreading a spread on either or both of the slices that create the sandwich.

Typically, the spread or other edible ingredient that is inserted between the two slices of bread may drip, spill or fall out of the sandwich, since such a sandwich is made out of two separate slices of bread, which are attached to one another only via the grip of the user eating the sandwich or via the stickiness of the ingredient inserted within (e.g., the stickiness of a spread such as peanut butter) but in fact there is an opening around the entire circumference of such a sandwich through which the edible ingredient may fall out.

Therefore, there is a need for a system and method for cutting a bread loaf into sandwiches that would prevent a spread or any other edible ingredient from dripping or falling out of the sandwiches.

### SUMMARY

An aspect of an embodiment of the disclosure relates to a system and method for cutting a bread loaf into sandwiches that comprise a closed portion at which the two slices creating the sandwich are attached and are not cut all the way through, i.e., two slices of bread comprising a pocket there between. The system and method may provide a bread loaf cut into sandwiches comprising sandwich pockets, such that these sandwiches comprise an open end or open portion through which a user may insert a spread or any other edible ingredient, while further comprising a closed portion that will prevent the spread or edible ingredient from dripping or falling out of the sandwich. For example, when the sandwich has a substantially square shape; the open portion may be on one side of the sandwich, while the closed portion may be on the other three sides of the sandwich.

In one embodiment of the disclosure, a system for cutting a bread loaf into sandwiches, each sandwich comprising two partially connected slices of bread with a pocket there between may comprise:
a loading unit for loading the bread loaf into the system;
a measuring unit for measuring an outline of the bread loaf;
a processor for determining a contour of a sandwich pocket; and
a cutting unit for cutting a sandwich pocket according to the determined contour, and for cutting its respective sandwich off the bread loaf.

In some embodiments, the loading unit may be a conveyer.

In some embodiments, the processor may be configured to receive user preferences comprising a sandwich width according to which the cutting unit cuts the bread loaf.

In some embodiments, the system may further comprise a packaging unit for packaging all cut sandwiches in one package. In some embodiments, the system may comprise a packaging unit for separately packaging each cut sandwich. In some embodiments, a packaging unit may package all separately packaged sandwiched in one package.

In some embodiments, an optimal pocket contour may be determined by the processor to be closest to the sandwich outline.

In some embodiments, the measuring unit may measure the outline of the bread loaf in order to determine the width of the next sandwich, and the contour of its respective sandwich pocket during cutting of the previous pocket or during cutting of the previous sandwich off the bread loaf.

In some embodiments, the system may comprise an exit through which the cut sandwiches exit the system.

In another embodiment of the disclosure, a method for cutting a bread loaf into sandwiches, each sandwich comprising two partially connected slices of bread with a sandwich pocket there between, may comprise:
inserting the bread loaf into a system for cutting sandwiches comprising sandwich pockets;
measuring an outline of the bread loaf, e.g. of a front portion of the bread loaf for cutting a sandwich;
determining the width of the sandwich and the contour of its respective pocket based on the measured outline of the bread loaf;
cutting the sandwich pocket, according to the determined sandwich pocket contour; and
cutting the sandwich off the bread loaf, according to the determined width.

In some embodiments, the method may comprise packaging all the cut sandwiches in one package. In some embodiments, the method may further comprise packaging each cut sandwich in a separate package. In yet further embodiments, the method may comprise packaging all the separately packaged sandwiches into one package.

In some embodiments, inserting the bread loaf into the system may be performed by loading the bread loaf onto a conveyer.

In some embodiments, measuring the outline of the bread loaf in order to determine the width of the next sandwich, and the contour of its respective sandwich pocket may be performed following every cut of a sandwich.

In some embodiments, measuring the outline of the bread loaf in order to determine the width of the next sandwich, and the contour of its respective sandwich pocket may be performed during cutting of the previous sandwich pocket or during cutting of the previous sandwich off the bread loaf.

In some embodiments, the method may comprise exiting the cut sandwiches out of the system.

In some embodiments, the width of the sandwich may be determined by a user per the user's preferences.

In some embodiments, an optimal pocket contour may be determined to be closest to the sandwich outline while having enough width such to not easily tear.

### BRIEF DESCRIPTION OF THE DRAWINGS

The present disclosure will be understood and better appreciated from the following detailed description taken in conjunction with the drawings. Identical structures, elements or parts, which appear in more than one figure, are generally labeled with the same or similar number in all the figures in which they appear. It should be noted that the elements or parts in the figures are not necessarily shown to scale such that each element or part may be larger or smaller than actually shown.

FIG. 1A is a schematic illustration of a flow chart of a system for cutting a bread loaf into sandwiches and creating sandwich pockets therein, according to an embodiment of the disclosure;

FIG. 1B is a schematic illustration of a system for cutting a bread loaf into sandwiches and for cutting sandwich pockets therein, according to an embodiment of the disclosure;

FIG. 2 is a schematic illustration of a flow chart of a method for cutting a bread loaf into sandwiches and creating sandwich pockets therein, according to an embodiment of the disclosure;

FIGS. 3A-3B are schematic illustrations of a top view and a side view of a loading unit for loading the bread loaf into the system for cutting a bread loaf into sandwiches with pockets, according to an embodiment of the disclosure;

FIGS. 4A-4C are schematic illustrations of two side views and a top-side view of a loading unit, according to another embodiment of the disclosure;

FIG. 5A is a schematic illustration of a measuring unit for measuring the outline of a bread loaf, which is part of the system for cutting a bread loaf into sandwiches with pockets, according to an embodiment of the disclosure;

FIG. 5B is a schematic illustration of is a schematic illustration of contours of various sandwich pockets, according to another embodiment of the disclosure;

FIGS. 6A-6D are schematic illustrations of a front-side view, exploded perspective side view, a front view and a perspective side-view of a section of a measuring unit, according to an embodiment of the disclosure;

FIG. 7 is a schematic illustration of a cutting unit, according to an embodiment of the disclosure;

FIGS. 8A-8C are schematic illustrations of a front view of a cutting unit that is part of the system for cutting a bread loaf into sandwiches with sandwich pockets, a front-side view of the cutting and measuring units, and a knife for cutting a bread loaf into sandwiches, respectively, according to an embodiment of the disclosure;

FIG. 9A is a schematic top view of the arms that hold the bread loaf during its cutting, according to an embodiment of the disclosure;

FIGS. 9B-9C, are schematic illustrations of a perspective view, and a back-side view of the door that holds the bread loaf during its cutting process and which opens after the cutting process is accomplished, according to an embodiment of the disclosure;

FIG. 10 is a schematic illustration of a packaging unit for packaging a cut sandwich, which is part of the system for cutting a bread loaf into sandwiches with sandwich pockets, according to an embodiment of the disclosure;

FIG. 11A-11B are schematic illustrations of the sandwich bag and guide door after the bag is open but the guide door is still closed, and after the guide door is open such to insert the sandwich into the bag, according to an embodiment of the disclosure;

FIG. 12 is a flow chart of operations performed by the packaging unit, according to an embodiment of the disclosure;

FIGS. 13A-13C are schematic illustrations of a backside view, a perspective-side view, and a front-side view of a packaging unit for packaging a cut sandwich, according to another embodiment of the disclosure;

FIGS. 14A-14B are schematic illustrations of a bread loaf packaging tray, according to an embodiment of the disclosure;

FIG. 14C is a schematic illustration of a packaging unit for packaging an entire bread loaf, according to an embodiment of the disclosure; and

FIGS. 15A-15B are schematic illustrations of a bread loaf packaging tray, according to another embodiment of the disclosure.

### DETAILED DESCRIPTION

In one embodiment of the disclosure, a method for cutting a bread loaf into sandwiches, while creating sandwich pockets therein, is disclosed. The method may comprise loading a bread loaf into a system for cutting such sandwiches comprising sandwich pockets, and measuring the outline of the bread loaf in order to determine the location of the cut of the sandwich pocket along the bread loaf, the contour of the sandwich pocket and the location along the bread loaf of the cut of the sandwich off the bread loaf. Following measuring the outline of the bread loaf and determining characteristics of the cut of both the sandwich pocket and the entire sandwich, cutting the pocket and sandwich takes place according to those measurements. The method may further comprise separately packaging each sandwich on its own, and/or packaging the entire sandwiches into one package, for ease of handling by the customer.

In another embodiment of the disclosure, a system for cutting a bread loaf into sandwiches, while creating pockets therein, is disclosed. The system may comprise several units: a loading unit for loading the bread loaf into the system, a measuring unit for measuring the outline of the bread loaf and determining the location and contour of the cut of the pocket and of the sandwich off the bread loaf, a cutting unit for cutting the sandwich pocket within the sandwich and for cutting the sandwich off the bread loaf, and a packaging unit for separately packaging each sandwich in a separate package, and/or for packaging all cut sandwiched into one package for ease of handling by the customer.

In the context of some embodiments of the present disclosure, without limiting, the contour of the bread loaf is defined as the shape and size of a cross-section of the brad loaf.

In the context of some embodiments of the present disclosure, without limiting, the contour of the sandwich pocket is defined as the shape or outline of the pocket as well as the distance of the pocket outline from the closed portion(s) of the sandwich or from the edges of the sandwich slices.

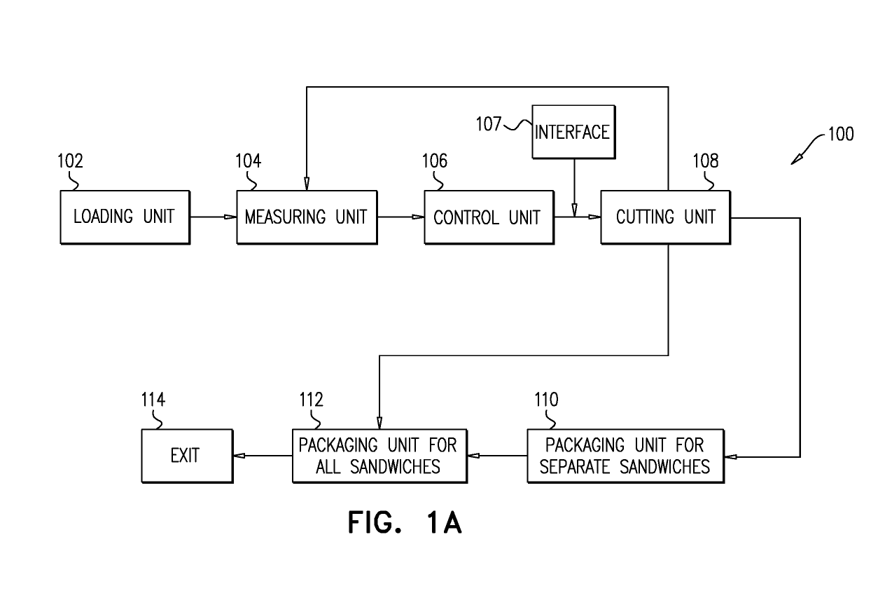

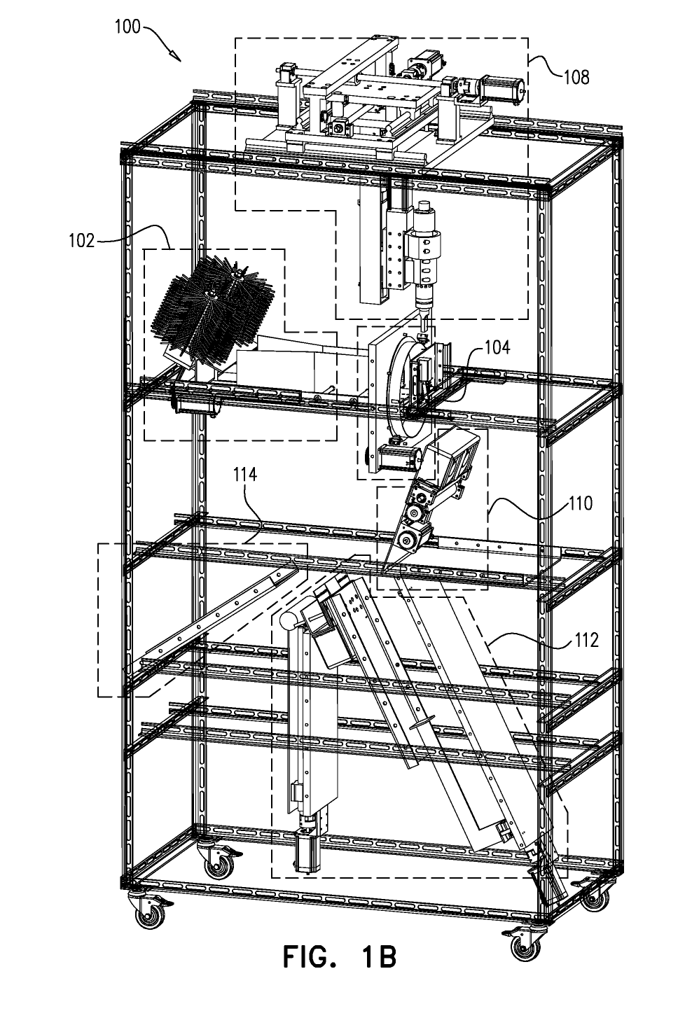

Reference is now made to FIG. 1A, which schematically illustrates a system for cutting a bread loaf into sandwiches and creating sandwich pockets therein, according to an embodiment of the disclosure. System 100 may be configured to cut a bread loaf into sandwiches, whereby each sandwich may be comprised of two partially connected slices of bread with a pocket cut between these two slices of bread. Accordingly, each sandwich may comprise an open end or an open portion and a closed end or a closed portion. An open end may be created by cutting the pocket all through the edge of the bread loaf, through which a spread of any kind or edible ingredient of any kind may be spread or inserted, respectively, into the sandwich pocket created in between the two slices of bread. A closed portion may be created by configuring the cut of the pocket not all the way through to the edge of the bread loaf, but rather by leaving a margin such to enable the two slices of bread to stay connected thus keeping the spread or food inserted into the sandwich within the sandwich, and preventing the spread or food placed into the pocket from dripping or falling out of the sandwich.

Typically, the closed portion is located along the edge of the sandwich which does not include the open end of the sandwich. In some embodiments, the open portion may occupy the majority of the circumference of the sandwich, whereas in other embodiments, the closed portion may occupy the majority of the outline of the sandwich.

In some embodiments, system 100 may comprise loading unit 102, which may be configured to load a bread loaf into the system. Loading unit 102 may comprise a conveyer, pulling/pushing brushes, a pushing mechanism or any other element that may assist in driving, propelling, thrusting, boosting or pushing the bread loaf into the system while preventing the customer from pushing his own hands into the system. Implementing a loading unit 102 in system 100 is done for safety reasons, e.g., in order to avoid injury to a customer resulting from various components of the system if the customer were to push his hands into the system. In addition, preventing the user from placing his hands into the system may assist in maintaining a clean and hygienic environment within the system. Furthermore, loading unit 102 may also be implemented for reasons of ease of use, such to minimize the actions that the user is required to perform prior to operation of system 100.

In some embodiments, loading unit 102 may be automatically operated once a bread loaf is placed onto it. Unit 102 may detect presence of the bread loaf by various sensors, e.g., a weight sensor that is to detect change in weight on loading unit 102, a photoelectric sensor that uses a beam of light for detecting presence of an object, etc. Once the sensor detects presence of a bread loaf placed onto loading unit 102, loading unit 102 may begin operating and pushing the bread loaf into system 100 in order to continue all subsequent steps required to produce a bread loaf cut into a plurality of sandwiches, each comprising a sandwich pocket therein.

In other embodiments, loading unit 102 as system 100, may be manually operated by a customer who wishes to cut the bread loaf he purchased, into sandwiches. Manual operation of system 100 and of loading unit 102 may include pressing a button, touching an icon on a touch screen, or moving a cursor, or any other indication that is translated into a command to start operation of system 100. In other embodiments, the user may slightly push the bread loaf in an initial push onto loading unit 102, which may cause initiation of loading unit 102, which may continue to pull/push the bread loaf onto it, and into system 100. In some embodiments, once manual operation is performed by the customer, all or some of the other steps that are required to produce a bread loaf cut into sandwiches, each comprising a sandwich pocket, are performed automatically.

In some embodiments, system 100 may further comprise a measuring unit 104. Measuring unit 104 may be connected to loading unit 102. Measuring unit 104 may be configured to measure an outline of the loaded bread loaf or a portion thereof, for example an outline of a front portion of the bread loaf which is to be cut into a next sandwich. Measuring unit 104 may comprise measuring sensors which may measure the distance between at least one point on the outline of at least a portion of the bread loaf and the measuring sensors. In some embodiments, the measuring sensors may measure the distance between a plurality of points along the outline of at least a portion of the bread loaf and the measuring sensors, for example by rotating around the circumference of the bread loaf to obtain each distance measurement. The measuring sensors, e.g., optical switch sensors, may also provide measurement of an angle from which such a distance measurement is obtained, such that the distance and respective angles are translated into the contour of the bread loaf or portion thereof. The contour of the bread loaf or the contour of the bread loaf cross section is important to measure since it affects the contour of the pocket that is to be cut by system 100, and may also affect the width of the sandwich that is to be cut by system 100.

In some embodiments, system 100 may further comprise control unit 106, which may be coupled to measuring unit 104. Control unit 106 may be an integral part of measuring unit 104 or may be a separate unit from measuring unit 104. In some embodiments, control unit 106 may be configured to make a determination based on the measurements performed by measuring unit 104, with regards to the width of the sandwich and the contour of the sandwich pocket that are to be cut by system 100. In some embodiments, based on the selected or designated width of each sandwich, the control unit 106 may calculate or estimate the number of sandwiches that may, be created from a given bread loaf, and may display the calculated number to the consumer or user or system 100.

Control unit 106 may receive a user/customer input regarding the user's preferences concerning the size, e.g., the width of at least one sandwich that is to be cut by system 100 via cutting unit 108. In some embodiments, control unit 106 may receive the user's input via a system input unit or interface 107.

In some embodiments, the user may define a single width per all sandwiches to be cut from a bread loaf, such that system 100 may cut all the sandwiches at the same width. However, in other embodiments, the user may define a first width per one sandwich or per a group of sandwiches, a second width that is different from the first width per a second sandwich or a second group of sandwiches, and a third, fourth and so on different widths per any number of sandwiches until reaching the total amount of sandwiches that may be cut from the bread loaf depending on the total length of the bread loaf. In other embodiments, the size, e.g., width of one or more sandwiches may be predefined by control unit 106. For example, the width of a sandwich may be between 10 mm to 25 mm.

In some embodiments, control unit 106 may be a central control unit, which may be coupled to or in communication with all units of system 100, such to control operation of all of the units of system 100. In some embodiments, measuring unit may comprise an internal controller that is configured to directly control the measuring process, and only then to send the measurement related data to the central control unit 106. Additional units may have an internal controller, e.g., system 100 may comprise a controller configured to control one or more engines of system 100, e.g., each of the three engines that operate the three axes cutting unit 108.

In some embodiments, central control unit 106 may be a computer, which may or may not be integrated with a screen or display. Any one of the internal controllers may be, for example, a controller selected from MSP430™ series of ultra-low-power microcontrollers by Texas Instruments, though any other controller may be implemented.

In some embodiments, the contour of the sandwich pocket may be determined by control unit 106 based on the measurements of the outline of the bread loaf. An optimal, preferred, or proper pocket size and contour may be defined as a pocket which is cut close to the edge of the bread loaf, such that the margin remaining between the pocket contour and the closed portion of the sandwich would be thin enough to enable insertion of a spread or any other edible ingredient very close to the edge of the sandwich, while avoiding tear or separation of the two slices of bread from one another. Such criteria for defining an optimal, proper or preferred pocket may enable attaining a maximal area of the sandwich pocket relative to the area of the sandwich slices, thereby maintaining a minimal area of margin between the pocket contour and the edges of the sandwich slices which is required in order to keep the two slices attached. The proper margin or distance between the pocket contour and the edges of the bread may be, for example, between 10 mm to 15 mm. The proper distance between the pocket and the edge of the bread may be substantially consistent all along the outline of the bread loaf/sandwich. In some cases, the proper margin may be dependent on various parameters, e.g. the type of bread, the width of the sandwich slices, or a preference of the consumer. In some embodiments, control unit 106 may send a command to cutting unit 108, with information regarding the size of the sandwich that is to be cut, as well as the contour of the pocket that is to be cut within the sandwich. Cutting unit 108 may comprise a knife, which may be made of a sufficiently hard material such as metal or plastic. The knife may be operated using back and forth cutting motion, or using vibrations. In some embodiments, the knife of cutting unit 108 may be configured to vibrate along an axis that is perpendicular to the axis along which the bread loaf is cut, in order to effectively cut the sandwich pocket and the sandwich off the bread loaf.

In some embodiments, cutting unit 108 may comprise an ultrasonic knife, which operates using ultrasonic vibrations. Precision of an ultrasonic knife is extremely high, in addition to the minimal amount of crumbs created by cutting with such a knife, which makes an ultrasonic knife a preferred selection to be implemented in cutting unit 108, though other knifes with other types of vibrations, e.g., subsonic vibrations, may be used.

According to some embodiments, cutting unit 108 may first cut a sandwich pocket with a pocket contour which is at a proper distance from the edge of the slice, such that the width of the two slices or the sandwich to be cut is according to a selected or predefined sandwich width. After cutting the pocket, according to the proper pocket size determined based on the outline of the bread loaf (as measured by measuring unit 104), a second cut is made by cutting unit 108. The second cut is made all the way through the bread loaf in order to separate the sandwich from the bread loaf. Thus, a sandwich with a sandwich pocket cut within, is created following the first and second cuts by cutting unit 108. In other embodiments, cutting unit 108 may first cut a slice of bread off the bread loaf at the proper width for a sandwich, either as selected by the user or per a predetermined or configurable width, and only then cut a pocket within the bread slice according to the proper size and contour as determined by control unit 106. However, it should be noted that it is less complex to keep the sandwich attached to the bread loaf while cutting the sandwich pocket compared to first detaching a sandwich from the bread loaf and only then cutting the sandwich pocket therein.

In some embodiments, system 100 may comprise a first packaging unit 110. Packaging unit 110 may be configured to package each and every sandwich that is cut by cutting unit 108. Packaging unit 110 may package each sandwich within a separate package. System 100 may further comprise a second packaging unit 112 that may be configured to package the entire amount of cut sandwiches into a single package. In some embodiments, system 100 may only comprise packaging unit 112, such to only package all the sandwiches together into one package. In other embodiments, system 100 may comprise both packaging unit 110 and packaging unit 112, such that each sandwich is initially packaged separately in its own package by packaging unit 110, and then all separately packaged sandwiches are packaged into one large package by packaging unit 112. In yet other embodiments, system 100 may only comprise packaging unit 110 such that the sandwiches are packaged in separate packages, and all these separately packaged sandwiches may exit system 100 to be collected by the user as individual sandwiches.

System 100 may further comprise an exit 114 through which the bread loaf that is cut into sandwiches with pockets may exit system 100 to be collected by the user. In some embodiments, the cut sandwiches may emerge out of exit 114 while separately packaged as individual sandwiches as well as packaged all together in one large package, or packaged in one large package without being initially packaged in individual packages.

In some embodiments, measurements of the outline of the bread loaf by measuring unit 104, in preparation of cutting a new sandwich, may be performed during the cutting process of either the pocket of the previous sandwich, or during the cutting process of the previous sandwich off the bread loaf. In other embodiments, measuring unit 104 may perform measurements of the outline of the bread loaf, in preparation for cutting a new sandwich, after the cutting process of the previous sandwich has been completed.

In some embodiments, measuring unit 104 may comprise a location sensor such to determine location and length of the bread loaf, e.g. along its longitudinal axis, with respect to the measuring unit. The location sensor may be implemented in order to determine whether there is still enough bread left in the bread loaf such to enable cutting off additional sandwiches. If the remaining bread loaf is shorter than the width of a new sandwich, no new cutting is performed, whereas if the bread loaf is long enough for cutting a new sandwich, then such a new sandwich is cut by cutting unit 108. The location sensor may sense the location and/or length of the bread loaf following every cut of a sandwich, in order to determine whether the bread loaf has been fully cut, is too short for a new sandwich, or may be cut further for an additional sandwich.

In some embodiments, the location sensor may be an optical distance measurement sensor, which may include a light emitter and a light detector, and may measure the distance to an object by detecting a light spot position of reflection on the light detector. For example, the location sensor may be an infrared distance measurement sensor, e.g. selected from Sharp's GP2Y0E series, e.g., any of GP2Y0E02A, GP2Y0E02B, or GP2Y0E03. Such distance sensors may be manufactured by Sharp Microelectronics, or Panasonic. In other embodiments, the location sensor may be laser based, acoustic based or may include an image sensor, e.g., a CMOS imager. Other optional location sensors may be selected from sonar sensors, ultrasonic distance measurement sensors, etc.

Reference is now made to FIG. 1B, which schematically illustrates a system for cutting a bread loaf into sandwiches and for cutting sandwich pockets therein, according to an embodiment of the disclosure. As described with respect to FIG. 1A, loading unit 102 may be configured to load a bread loaf into system 100. Loading unit 102 may be connected to measuring unit 104, which may be configured to periodically, continuously, or substantially continuously measure the contour of the bread loaf or a portion of the bread loaf that was loaded into system 100 via loading unit 102. In fact, measuring unit 104 may measure the cross section of the bread loaf or the cross section of a portion thereof, e.g. in order to measure the cross section of each new sandwich before cutting it.

In some embodiments, system 100 may comprise a central control unit configured to control all units of system 100, e.g., central control unit 106 (FIG. 1A). However, in some embodiments, in addition to a central control unit, which may be located at the bottom side of system 100, (though other locations are possible including remote locations), measuring unit 104 may comprise an internal controller such to control in real-time the measurements performed by measuring unit 104. The internal controller (not shown) of measuring unit 104 may ensure that the bread loaf contour measurements are promptly recorded by the internal controller and avoid loss of any measurements if they were to be recorded by the central control unit. Loss of measurements may occur since it may take longer to send the measurements to the central control unit instead of recording the measurements locally using an internal controller and only then sending all recorded measurements to the central control unit.

In some embodiments, system 100 may comprise a cutting unit 108, which may be configured to cut a sandwich pocket as well as to cut a sandwich off the bread loaf. The cutting scheme according to which cutting unit 108 may cut the sandwich pocket and the sandwich, may be determined by a processor that may be coupled to or may be an integral unit of central control unit 106.

Following cutting of the sandwich pocket and following cutting of the sandwich off the bread loaf, the sandwich may enter or may be directed into a first packaging unit 110, which may be configured to separately package each single sandwich. All of the separately packaged sandwiches may then accumulate onto a second packaging unit 112, which may be configured to package the entire bread loaf (which is cut into sandwiches) into a single large package that is sized to contain the entire bread loaf. System 100 may further comprise exit 114, through which the packaged bread loaf may exit system 100 such to be collected by the customer. In some embodiments, exit 114 may comprise an exit tray, though in other embodiments, exit 114 may comprise other elements.

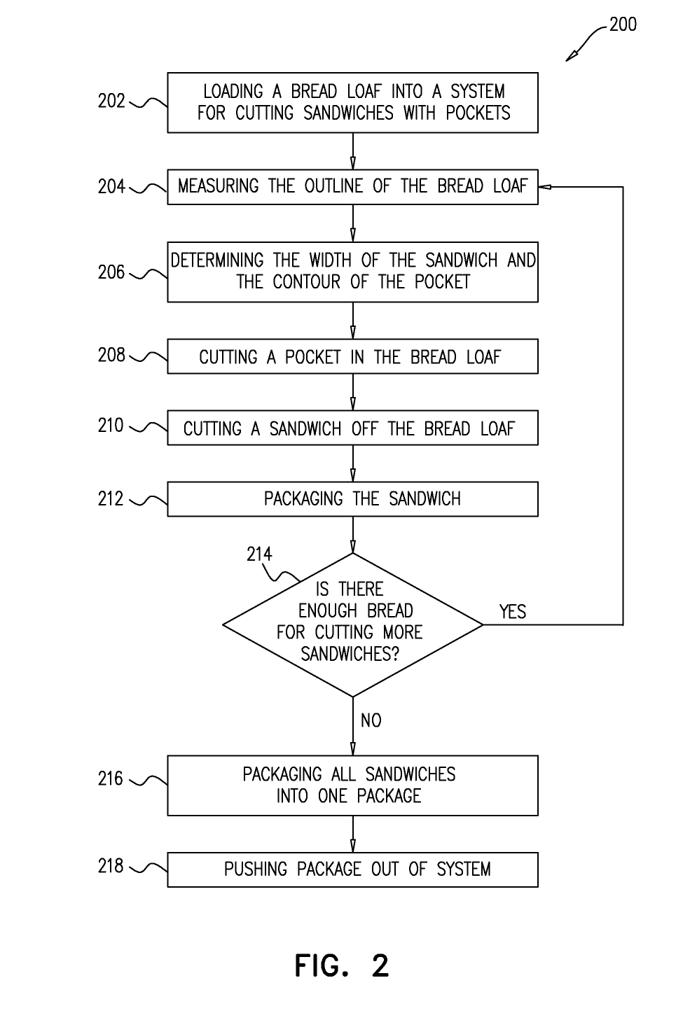

Reference is now made to FIG. 2, which schematically illustrates a flow chart of a method 200 for cutting a bread loaf into sandwiches comprising two partially connected slices of bread, thereby creating pockets between the two slices, according to an embodiment of the disclosure. In some embodiments, method 200 may comprise step 202 of loading a bread loaf into a system for cutting a bread loaf into sandwiches, such that each sandwich comprises two partially connected slices of, bread with pockets created between the two slices. The loading step 202 may comprise placing or positioning the bread loaf into a loading unit, e.g., loading unit 102 (FIGS. 1A-1B). In some embodiments, regardless of the position or placement of the bread loaf into loading unit 102, the bread loaf may be automatically aligned to a selected position, e.g. aligned with a longitudinal axis of the bread loaf. The loading unit of the system may comprise a conveyer, brushes, a driver, a pushing or pulling mechanism or any other mechanism that may drive or direct the bread loaf into the system.

The method 200 may further comprise step 204 of measuring the outline of the bread loaf or of a portion of the bread loaf. Step 204 of measuring the outline of the bread loaf may be performed by a measuring unit, e.g., measuring unit 104 (FIGS. 1A-1B), which may be part of the system for cutting a bread loaf into sandwiches with pockets. The outline of the bread loaf may be measured along a cross section of a longitudinal axis of the bread loaf, e.g. a front portion of the bread loaf from which the next sandwich is to be cut.

Following measuring the outline of the bread loaf in step 204, the method may comprise step 206 of determining the width of the sandwich and determining the contour of the sandwich's respective pocket that should be cut by the system 100. Determination regarding the size of the sandwich that is to be cut by the system 100, and further regarding the contour of the pocket that is to be cut such to create a sandwich that is open on one end, while being closed on another, typically opposite end, is made based on the measurements of the bread loaf outline performed in step 204. The step 206 of determining the width of the sandwich and the contour of its respective pocket may be performed by a controller, e.g., control unit 106 (FIG. 1A) that may be coupled to the measuring unit, which performs the measuring step 204. Determining the width of the sandwich may additionally or instead be based on a configurable or predefined width parameter which may be stored in control unit 106, or may be based on a width input received from the consumer via a system input unit or interface 107 (FIG. 1A).

Following determining the width of the sandwich and size and contour of its pocket that should be cut, in step 206, the method may comprise step 208 of cutting a sandwich pocket in the bread loaf. In some embodiments, the pocket is first cut within the bread loaf by a cutting unit, and only then step 210 of cutting a sandwich off the bread loaf takes place, since it may be more complex to first cut a slice off the bread loaf and only then to cut a pocket therein, in order to create the pocketed sandwich comprising one open portion and one closed portion. It may be simpler, quicker and thus more cost effective to first cut the pocket and only then cut the entire sandwich off the bread loaf. The cutting of both the pocket and the sandwich off the bread loaf may be done by a cutting unit, e.g., cutting unit 108 (FIGS. 1A-1B).

The method may comprise an optional step 212 of packaging the cut sandwich in a designated and individual package. Packaging each cut sandwich into an individual package may be performed by a packaging unit, e.g., packaging unit 110 (FIGS. 1A-1B).

In some embodiments, as mentioned above, the system may comprise a processor, controller and/or control unit that may be coupled to the measuring unit, and which may control measuring of the bread loaf as an initial step prior to cutting a new sandwich, either after a previous sandwich is cut off the bread loaf, or during cutting of a previous sandwich off the bread loaf or during cutting of a pocket of a previous sandwich. In addition, the system may comprise a location sensor for determining location of the bread loaf with respect to the measuring unit, such to determine the amount of bread loaf remaining following a cut of a sandwich. Such a location sensor may also be coupled to the measuring unit, as is the control unit. Therefore, according to step 214, such a location sensor may determine whether there is a sufficient amount of bread for cutting more sandwiches, or whether the bread loaf is too small for cutting an additional sandwich, or even whether there is nothing left of the bread loaf since it was already fully cut into sandwiches.

If there is still enough bread remaining of the bread loaf for cutting additional sandwiches, then the method returns to step 204 of measuring the outline of the bread loaf, such to determine the size and contour of the pocket and the width of the sandwich, as in step 206, and further to cut the pocket and sandwich as in steps 208 and 210, respectively, and so on. However, if there is not enough bread for cutting more sandwiches, then the method may comprise step 216 of packaging all the cut sandwiches into one package. Step 216 of packaging the entire sandwiches into one package may be performed by the same packaging unit that may package each sandwich in a separate package, or it may be performed by a separate designated packaging unit for packaging all the sandwiches into one large package, e.g., packaging unit 112 (FIGS. 1A-1B).

Finally, the method may comprise step 218, for pushing or directing the package comprising all sandwiches to an exit tray or collection unit (e.g., through exit 114, (FIGS. 1A-1B) such that the packaged sandwiches may be available to be collected by the customer.

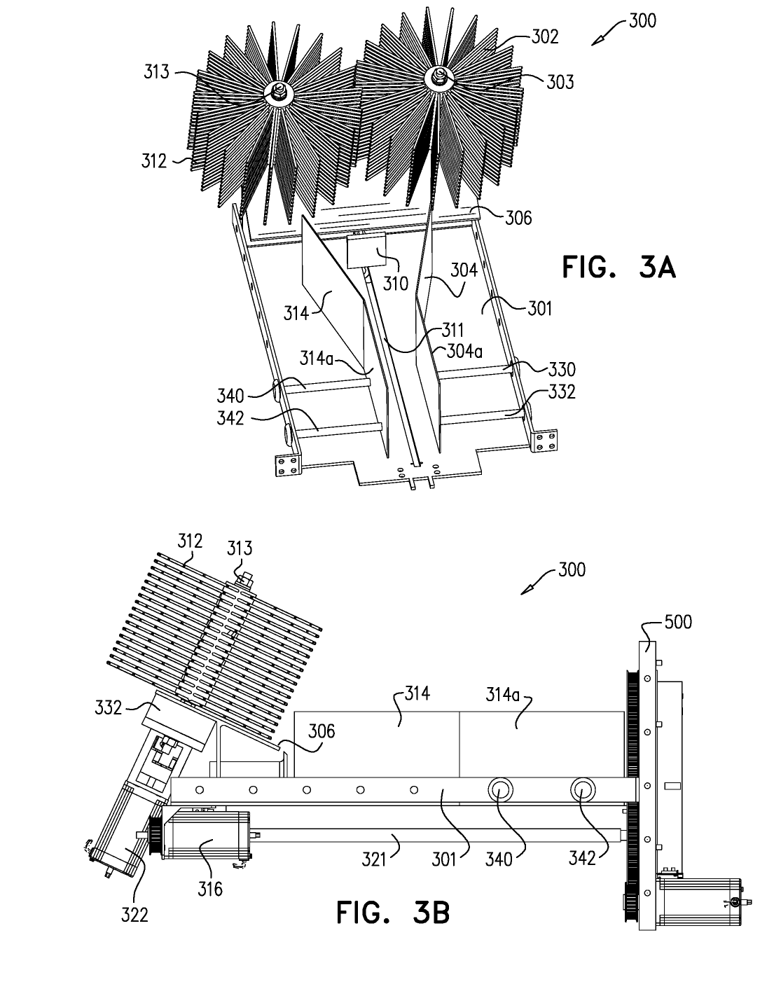

Reference is now made to FIGS. 3A-3B, which schematically illustrate a top view and a side view of a loading unit for loading the bread loaf into the system for cutting a bread loaf into sandwiches with pockets, according to an embodiment of the disclosure. According to some embodiments, loading unit 300 may be configured to load a bread loaf into the system for cutting a bread loaf into sandwiches with pockets therein. Loading unit 300 may comprise at least two brushes, e.g., brush 302 and brush 312, which may be located on opposite sides of tray 306. When a user places a bread loaf in between brushes 302 and 312, the brushes may turn around shafts 303 and 313, respectively, such to push the bread loaf onto tray 306.

The bread loaf may then slide over tray 306 until it lands on base 301, between flaps 304 and 314, which may be located on opposite sides of base 301. The shape created by flaps 304 and 314 onto base 301, may be similar to a Y shape, such that there is an opening created between flaps 304 and 314 close to the location where tray. 306 ends and base 301 begins. Flaps 304 and 314 are located further along the base 301, and connected to them are aligners 304a and 314a, respectively. Aligners 304a and 314a take on a shape of a substantially straight line (this is the “leg” of the Y shape), which is configured to align the bread loaf at a certain angle with respect to the measuring unit 500 (FIG. 3B).

Loading unit 300 may further comprise a pushing mechanism 310, which may be located at the connection between tray 306 and base 301. In some embodiments, pushing mechanism 310 may be configured to shove and push the bread loaf in between flaps 304 and 314, such that the longitudinal axis of the bread loaf will be aligned in between aligners 304a and 314a and be perpendicular with respect to the contour of measuring unit 500. Pushing mechanism 310 may also be configured to push the bread loaf while between flaps 304 and 314 so that the bread loaf reaches measuring unit 500 in order to begin the measuring process. Pushing mechanism 310 may be operated by a motor 321 (FIG. 3B) and the bread loaf may be moved along a rail 311, which is located in the middle of the plane defined by base 301.

Since the width, size or diameter of bread loaves may vary, and in order to properly align a bread loaf of any size, with respect to the measuring unit 500, aligners 304a and 314a may be connected to pins that may change or automatically modify their length in order to adjust the space between aligners 304a and 314a to fit the size (e.g., width or diameter) of the bread loaf. In some embodiments, aligner 304a may be connected to pins 330 and 332, while aligner 314a may be connected to pins 340 and 342. In some embodiments, pin 330 may be located at a distance from pin 332, along the plane defined by base 301. In some embodiments, pin 340 may be located at a distance from pin 342, along the plane define by base 301. Each of pins 330, 332, 340 and 342 may be connected to a spring, which may enable the pins to move back and forth in a direction that is perpendicular to the direction of movement of pushing mechanism 310 along rail 311. The springs may be soft springs that would enable movement of the pins once slight forces are applied by the bread loaf onto the pins 330, 332, 340 and 342 and thus onto their respective springs. That is, the mere push of a bread loaf in between aligners 304a and 314a causes all pins to move backwards such to make room for the bread loaf to continue passing along aligners 304a and 314a.

When pushing mechanism 310 pushes the bread loaf between aligners 304a and 314a, each of the pairs of pins, e.g., the pins 330 and 332 on one side of the bread loaf and the pins 340 and 342 on the other side of the bread loaf may be pushed back, respectively, in order to create space for the bread loaf through which to enter between aligners 304a and 314a, in a direction that is perpendicular to the direction of movement of pushing mechanism 310 along rail 311, further away from rail 311. For example, pins 330 and 332 may both be pushed away from rail 311, along an axis that is perpendicular to the direction of movement of pushing mechanism 310 along rail 311, while pins 340 and 342 may both be pushed along an axis that is perpendicular to the direction of movement of pushing mechanism 310, and further away from rail 311 towards a side that is opposite the side towards which pins 330 and 332 are pushed. A controller may be configured to control the movement of pushing mechanism 310, though instead of an internal controller, the movement of pushing mechanism 310 may be controlled by a central control unit, e.g., central control unit 106 (FIG. 1A).

As described in FIG. 3B, brush 312 may be connected to a motor 332, which may be configured to operate the rotation movement of brush 312. Similarly, brush 302 may be operated by a respective motor (not shown).

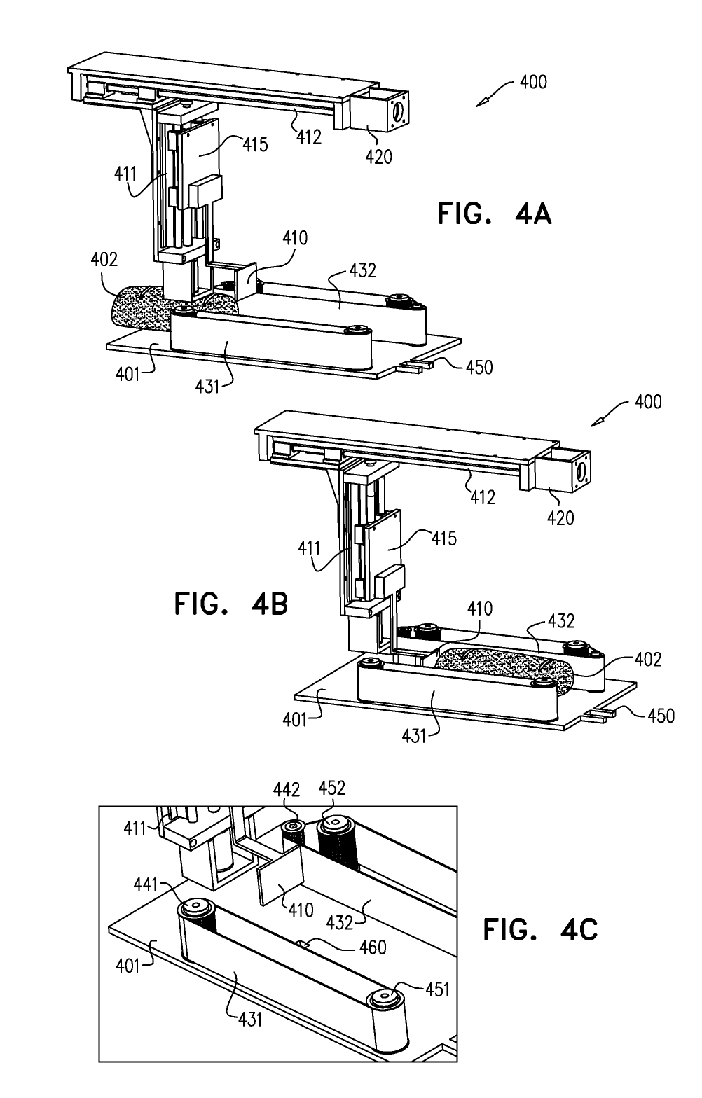

Reference is now made to FIGS. 4A-4C, which schematically illustrates two side views and a top view of a loading unit, according to another embodiment of the disclosure. Loading unit 400 may be used instead of loading unit 300 (FIGS. 3A-3B), as part of a system for cutting sandwiches with pockets therein. Loading unit 400 may comprise a tray 401 onto which a user or customer may place a bread loaf, e.g., bread loaf 402. Connected to tray 401 may be arm 411, while arm 411 may be located perpendicular to tray 401. Arm 411 may comprise an extension 420, which may comprise a rail 412. Rail 412 may pass along extension 420, while both rail 412 and extension 420 may be perpendicular to arm 411 and parallel to tray 401.

Arm 411 may further comprise a pushing mechanism 410. Pushing mechanism 410 may be positioned in parallel to the vertical axis of arm 411, and may move along rail 412 such to push the last or substantially last piece of bread loaf 402 that is to be cut, towards the entrance of the measuring unit. Pushing mechanism 410 may also be moved up and down along the vertical axis of arm 411 by arm 415 such to raise above tray 401 when no bread loaf has yet entered tray 401, or be lowered down towards tray 401 such to be used to push bread loaf 402 (e.g., the final piece of bread loaf 402) towards the measuring unit.

Prior to operation of pushing mechanism 410, two conveyers may be configured to push the bread loaf 402 along tray 401. For example, conveyer 431 may be located on one side of tray 401, perpendicular to the plane defined by tray 401, while conveyer 432 may be located on another side of tray 401, perpendicular to the plane defined by tray 401, whereby the conveyers 431 and 432 may be located parallel to one another. Bread loaf 402 may be pushed by conveyers 431 and 432 such to pass between the conveyers 431 and 432, as the conveyers turn around their respective pulleys. Conveyer 431 may comprise pulley 441 and pulley 451 around which the conveyer belt may turn. Conveyer 432 may comprise pulley 442, pulley 452 and may comprise additional pulleys (not shown) around which the conveyer belt of conveyer 432 may turn. Simultaneous turning of the conveyer belts 431 and 432 may cause bread loaf 402 to lie pushed along tray 401. Pushing mechanism 410 may be used in order to push the end of the bread loaf 402 so that the end of bread loaf 402 reaches the end of tray 401, which is also the beginning of the measuring unit. Since pushing a small piece of bread might not be properly achieved by merely using conveyers 431 and 432 on both sides of the small piece, pushing mechanism 410 that may be located behind bread loaf 402 may be operated to push the small piece of bread loaf further.

Determination regarding the location and remaining length of bread loaf 402 and thus controlling operation of pushing mechanism 410, may be made based on measurements of a presence sensor 460 (FIG. 4C). Presence sensor 460 may be located at a certain predetermined location along tray 401, and its distance from either end of tray 401 is also predetermined, thus when the bread loaf is located on top of presence sensor 460, a controller (not shown) may operate arm 411 to lower pushing mechanism 410 until pushing mechanism 410 reaches or almost reaches tray 401, in order to push bread loaf 402 towards the measuring unit. In other embodiments, pushing mechanism 410 may be configured to operate such to only push the final or substantially final piece of bread loaf, since the majority of the bread loaf may be pushed along tray 401 by motion of conveyers 431 and 432.

Conveyers 431 and 432 may provide a pushing force onto the bread loaf 402 while turning around their respective pulleys, as well as provide alignment of bread loaf 402 with respect to the location of the entrance to the measuring unit, e.g., measuring unit 500 located adjacent to loading unit 300 (FIG. 3B). In some embodiments, and as illustrated in FIG. 4C, conveyer 431 may be static in such that it may not change its location along the plane defined by tray 401. However, conveyer 432 may be adjustable or moveable along the plane defined by tray 401, such to move farther away from conveyer 431 in order to enable any size of bread loaf to enter between conveyer 431 and conveyer 432. Conveyer 432 may be moveable by being connected to a spring which may compress when force is applied onto it, e.g., when a bread loaf is pushed forward between conveyer 431 and conveyer 432 and thus pushes conveyer 432 away from conveyer 431 in order to expand the space between the conveyers and to enter into that created space. The bread loaf may be maintained constantly aligned with respect to the measuring unit, such to be able to enter it freely in order to allow all measurements to take place.

As illustrated in FIG. 4A, brad loaf 402 may enter tray 401 while pushing mechanism 410 is located above of bread loaf 402. Pushing mechanism 410 is still located above bread loaf 402 since bread loaf 402 hasn't been pushed enough by conveyers 431 and 432 to fully enter tray 401, such to allow pushing mechanism 410 to enter behind bread loaf 402. FIG. 4B illustrates pushing mechanism 410 located at its lower position along arm 411, ready to push bread loaf 402 towards the measuring unit. In FIG. 4B, the conveyers 431 and 432 pushed bread loaf 402 along tray 401 such to provide space for pushing mechanism 410 to enter behind bread loaf 402 for continued pushing motion towards the exit of loading unit 400 and into the measuring unit. Loading unit 400 may be connected to the measuring unit via connector 450. Conveyers 431 and 432, and/or pushing mechanism 410 may continue to push bread loaf 402 forward through the measuring unit, following each measuring process performed prior to cutting a new sandwich, until the entire bread loaf 402 is measured by the measuring unit and the final pocket is cut in the final sandwich of bread loaf 402.

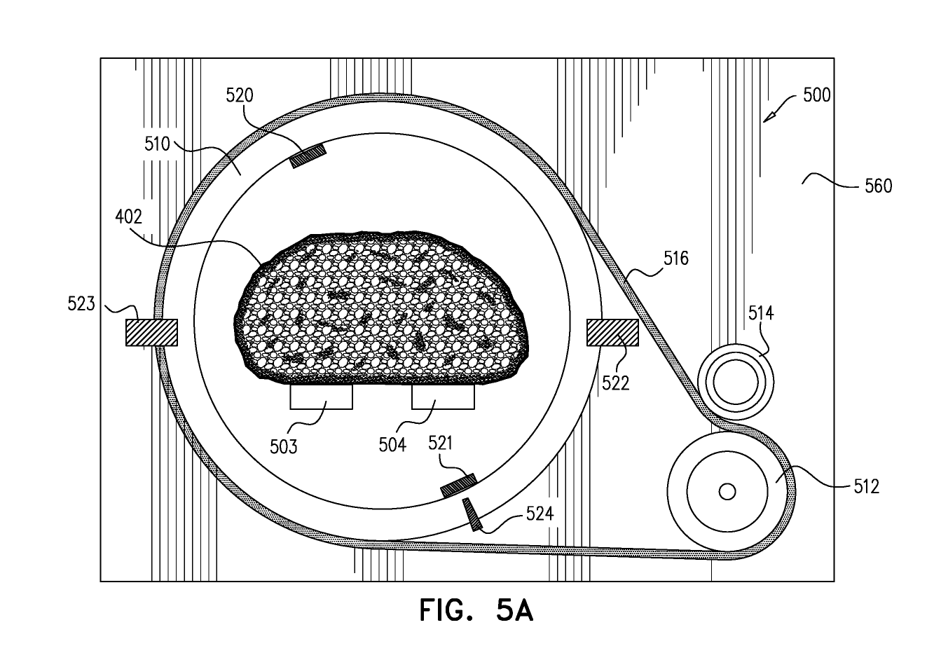

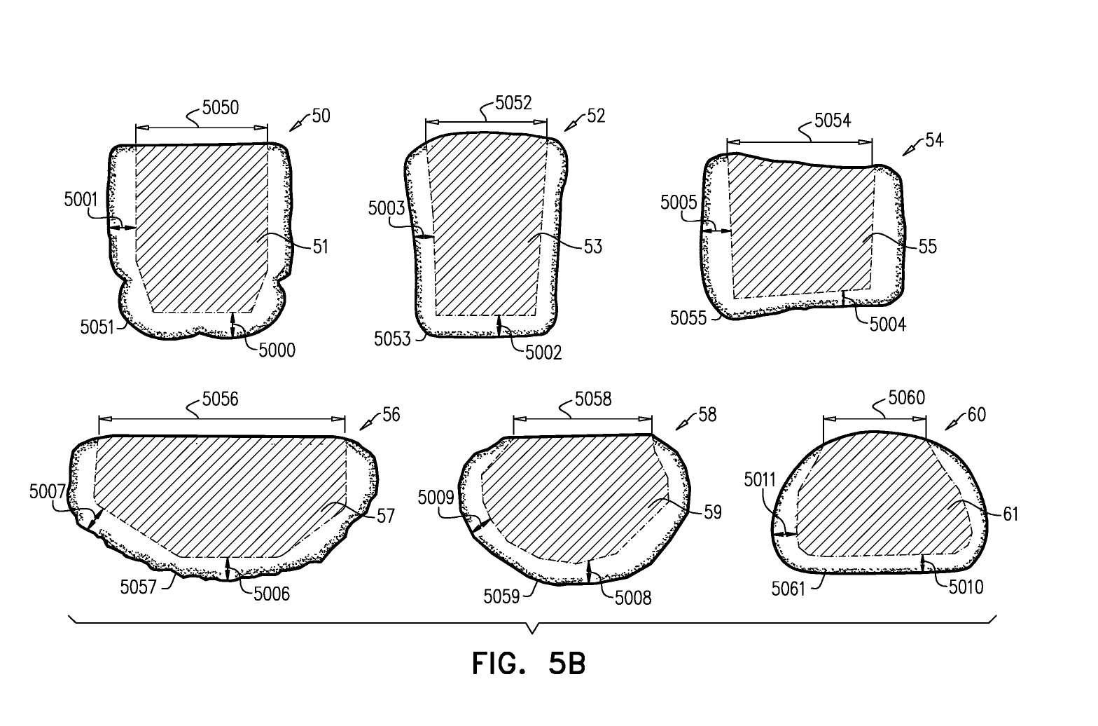

Reference is now made to FIG. 5A, which schematically illustrates a measuring unit for measuring the outline of a bread loaf, which is part of the system for cutting a bread loaf into sandwiches with pockets, according to an embodiment of the disclosure. Once a bread loaf, e.g., bread loaf 402, is pushed into measuring unit 500 by the loading unit (e.g., loading unit 300 or 400), the process of measuring the outline of bread loaf 402 may begin. Measuring unit 500 may comprise a frame 560 onto which all or at least a portion of components of measuring unit 500 may be attached. Measuring unit 500 may comprise at least two lying arms 503 and 504 that hold the bread loaf 402 while it is positioned inside measuring unit 500. Arms 503 and 504 may typically be of a small width in order to prevent arms 503 and 504 from hiding the outline of bread loaf 402, which is to be fully measured by measuring unit 500, while providing enough stability for the bread loaf 402 to rest on arms 503 and 504. The distance between arm 503 and arm 504 is configured to be large enough to enable measuring the maximum outline of bread loaf 402 located in between the arms. For example, if the typical bread loaf has a width or diameter between 10 cm to 15 cm, the distance between leg 503 and leg 504 may be between around 25 mm±10 mm. In some example, the width of each of leg 503 and leg 504 may be approximately 5 mm. In other embodiments, other widths and distances may be implemented.

In some embodiments, measuring unit 500 may comprise a measuring ring 510 onto which the sensors for measuring the bread loaf outline, are located. Measuring ring 510 may have attached on the inner side of its circumference, at least two distance sensors, e.g., distance sensor 520 and distance sensor 521, each configured to measure the distance between the circumference of measuring ring 510 and the bread loaf 402. The distance between the circumference of the measuring ring 510 and the bread loaf 402, may be determined as the distance between any of distance sensors 520 or 521 and the bread loaf 402. Measuring ring 510 may be rotatable, and may be rotated around bread loaf 402 while distance sensors 520 and 521 may continuously, substantially continuously or periodically measure the distance between the measuring ring 510 and bread loaf 402. In other embodiments, only a discrete number of measurements may be acquired by each of distance sensor 520 or distance sensor 521. The number of measurements acquired by either of the distance sensors 520 or 521 may be predetermined.

Typically, distance sensor 520 may be located across distance sensor 521, such that 180 degrees separate between the two distance sensors 520 and 521. That is, the location of the distance sensors 520 and 521 along the circumference of measuring ring 510 is along a diameter of the circumference, and creates an imaginary half circle. In case distance sensor 520 is indeed located across distance sensor 521, there is no need for measuring ring 510 to complete an entire cycle of rotation around bread loaf 402 but rather to only complete half a cycle of rotation, since during half a cycle the entire circumference of bread loaf 402 is measured by the two sensors; half of the outline of bread loaf 402 may be measured by distance sensor 520 while the other half of the outline of bread loaf 402 may be measured by distance sensor 521. If more than two distance sensors are implemented on the inner side of the circumference of measuring ring 510, such that the distance between any pair of distance sensors is identical to the distance between any other pair of distance sensors, measuring ring 510 may rotate around bread loaf 402 such to complete a cycle even smaller than half a cycle. In some embodiments, other numbers of distance sensors may be used. Furthermore, the measuring ring 510 may not necessarily be configured as a ring, and need not necessarily rotate.

In some embodiments, the location sensor may be an optical distance measurement sensor, which may include a light emitter and a light detector, and may measure the distance to an object by detecting a light spot position of reflection on the light detector. For example, each of distance sensors 520 and 521 may be selected from Sharp's GP2Y0E series, e.g., any of GP2Y0E02A, GP2Y0E02B, or GP2Y0E03. Such distance sensors may be manufactured by Sharp Microelectronics, or Panasonic. In other embodiments, the distance sensors 520 and 521 may be laser based, acoustic based or may include an image sensor, e.g., a CMOS imager. In some embodiments, other or additional distance sensors may be used, e.g. sonar sensors, ultrasonic measurement sensors, or any combination thereof.

Measuring unit 500 may further comprise two optical switch sensors 522, and 523, as well as a flap 524. Switch sensors 522 and 523 may be stationary, and may be located onto frame 560 in close proximity to measuring ring 510. Flap 524 may be attached to the outer side of the circumference of measuring ring 510, thus flap 524 may move simultaneously with movement, e.g., rotation, of measuring ring 510. When flap 524 enters into the space associated with either of switch sensors 522 or 523, flap 524 may obstruct the path of light beam, causing a low voltage output, as compared to the high output when the light beam is not interrupted by flap 524. In some embodiments, optical switch sensor 522 may be located across optical switch sensor 523, such that the distance between the two switch sensors may be of 180 degrees.

Once measuring ring 510 is rotated and flap 524 enters the space associated with switch sensor 522, it may be determined that the measuring ring 510 begins its half rotation cycle of measuring the outline of a bread loaf. Once measuring ring 510 is rotated such that flap 524 enters the space within switch sensor 523, it may be determined that measuring ring 510 has finished half a rotation cycle of measuring the outline of a bread loaf. Since the distance between switch sensor 522 and switch sensor 523 is predetermined as being 180 degrees, each step or rotational movement that measuring ring 510 performs during its rotation cycle, may be translated into a certain angle, with respect to the spatial location of either of switch sensor 522 or switch sensor 523. For example, the location of switch sensor 522 may be defined as an angle of zero degrees, while the location of switch sensor 523 may be defined as an angle of 180 degrees, since the distance between switch sensor 522 and switch sensor 523 may be predetermined and set to 180 degrees (when switch sensors 522 and 523 are located one across the other on the measuring ring outline, and along two points that are located on a diameter of measuring ring 510).

In one embodiment, the controller of measuring ring 510 (e.g. controller 106 or another controller) may be configured to rotate the measuring ring 510 to one or more configurable or predetermined angles. In another embodiment, the controller of measuring ring 510 may be configured to rotate the measuring ring 510 and stop the rotation based on feedback from switch sensors 522, 523.

Each rotation motion of measuring ring 510 may be referred to herein as a step or a rotational movement. A predetermined amount of steps or rotational movements performed by measuring ring 510 may be required in order to complete the measurement of the bread loaf outline. For example, in order to complete sensing the outline of the bread loaf along a plurality of points, the location of switch sensor 523 may be defined as 180 degrees and the location of switch sensor 522 may be defined as zero degrees. Thus, each step may be translated into a certain angle or arc (with respect to the angle of zero degrees defined by the location of switch sensor 522), by dividing 180 into the total number of steps. That is, any number of steps performed by measuring ring 510 from the location of switch sensor 522 towards the direction of the spatial location of switch sensor 523, may be translated into a specific movement angle or arc of the measuring ring 510.

It is noted that the exemplary embodiment of a ring that rotates to complete half a circle in order to measure the outline of a bread loaf is brought only as an example for measuring the outline of the bread. Other embodiments may be implemented, e.g. by using less measuring sensors and rotating the measuring ring a full rotation, or, by using more sensors and not rotating the ring at all. In yet other embodiments, the measuring sensors need not be positioned along a ring, but may be positioned in any other spatial configuration, and may be calibrated in order to obtain correct distance measurements from the sensors to the outline of the bread loaf.

According to some embodiments, every distance measurement acquired by either of distance sensors 520 or 521 may be acquired at a different angle with respect to the location of either of switch sensor 522 or switch sensor 523. That is, distance measurements may be acquired by distance sensors 520 and 521, while the corresponding angle (or arc) from which such distance measurement were acquired may be inferred via switch sensors 522 and 523, as explained above. The measured distances may be assigned with their corresponding angle at which each of these distances were acquired, and these pairs of distance and respective angle may be obtained and recorded by a processor (not shown), e.g. controller 106, that may calculate the outline of the bread loaf 402 according to the information provided by these pairs of distance-angle.

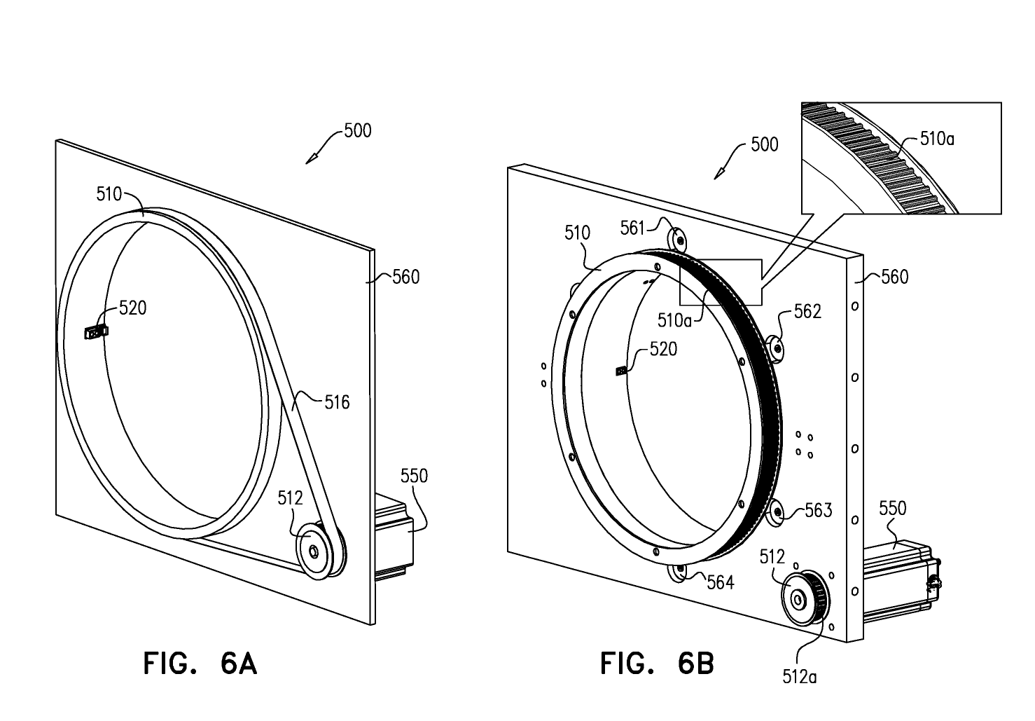

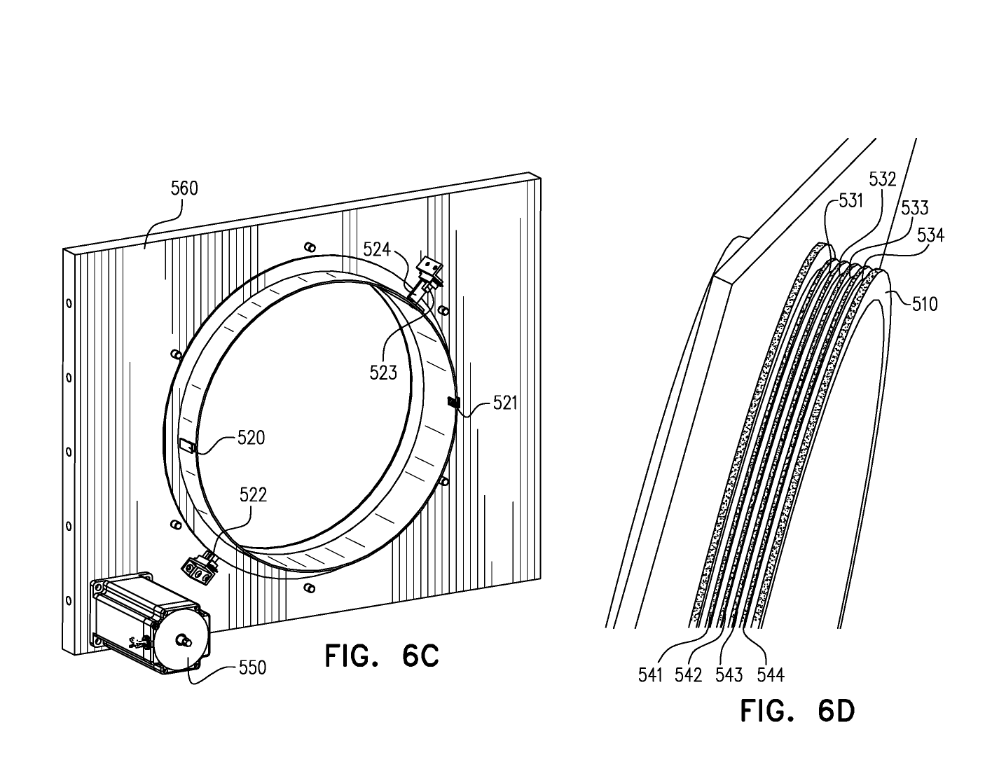

Measuring ring 510 may be rotated around bread loaf 402 by a timing belt 516, which rotation may be operated by a motor 550 (FIG. 6A). Timing belt 516 may be wrapped around measuring ring 510 as well as around wheel 512. In some embodiments, wheel 512 may be directly coupled to motor 550, such that motor 550 may cause wheel 512 to rotate, which in turn causes timing belt 516 to move around measuring ring 510 thereby causing measuring ring 510 to rotate around bread loaf 402.

Measuring unit 500 may further comprise belt tensioner 514, which is configured to ensure belt 516 is looped around wheel 512 and further around measuring ring 510 at an appropriate high tension to ensure smooth turning of measuring ring 510 and of wheel 512.

Reference is now made to FIG. 5B, which schematically illustrates contours of various sandwich pockets, according to an embodiment of the disclosure. In some embodiments, a processor may be in communication with the measuring unit, e.g. processor which may be included in controller 106, such that the processor may be configured to determine a contour of a sandwich pocket that is to be cut by a cutting unit 108. The processor may calculate the contour of the sandwich pocket based on measurements of the contour of each new sandwich, as performed by the measuring unit 500. The processor may calculate an optimal or proper pocket contour such that the width of margin or distance, e.g., width 5001 between the contour of the sandwich pocket, e.g., sandwich pocket 51 and the edge of the sandwich, e.g., sandwich 50, is of a predetermined or configurable width, or a minimal width.

In some embodiments, the width of the margin or distance of the contour of the sandwich pocket from the edge of the sandwich may be different at different locations along the edge of the sandwich. For example, width 5000 of the margin, which may be located at the bottom end of sandwich 50, may be smaller compared to width 5001 of the margin, which may be located at a side positioned perpendicularly to the bottom side of sandwich 50. In some embodiments, the margin of the contour of the sandwich pocket from the edge of the sandwich may be substantially the same along the entire edge of the sandwich. For example, width 5002 of the margin, which may be located at the bottom end of sandwich 52 may be of substantially the same size as width 5003 of the margin, which may be located perpendicularly to width 5002.

In some embodiments, the processor may calculate a proper pocket contour such that the width of the margin of the contour of the sandwich pocket from the edge of the sandwich may be minimal at any location along the edge of the sandwich. In some embodiments, the processor may calculate a configurable pocket contour such that the width of the margin of the contour of the sandwich pocket from the edge of the sandwich may be configurable, and may be uniform or varied in any location along the edge of the sandwich.

An optimal or proper margin of the sandwich pocket from the edge of the sandwich may be based on the type of bread that is to be cut, for example, there are breads made of soft dough compared to other breads made of stiffer dough. In bread loaves made of soft dough, the margin or distance of the sandwich pocket contour from the edge of the sandwich should be larger compared to the distance of the sandwich pocket contour from the edge of the sandwich in stiff bread loaves, since soft dough tends to tear more easily compared to stiff dough.

In some embodiments, the processor may calculate an optimal, minimal or proper sandwich pocket contour based on various parameters of the bread loaf (e.g., type of dough, whether or not the bread contains any additions to the dough, e.g., raisins, nuts, etc.). In other embodiments, the processor may be configured to determine the same pocket distance from the sandwich edge per any sandwich, regardless of the bread's parameters or type.

In some embodiments, the processor may receive user preferences, which may comprise the width of a sandwich, while in other embodiments, the processor may be programmed to implement a predetermined sandwich width.

The various sandwich cross-sections illustrated in FIG. 5B, which comprise a sandwich pocket, are only examples of endless shapes of bread loaves and thus of endless shapes of sandwiches. It should be clear that the position and orientation at which the bread loaf is inserted into the system affects the location of the sandwich pocket. For example, assuming the cutting unit is located above each of the illustrated sandwiches, sandwich 52 that has the shape of a rectangle, may be inserted into system 100 such that one of its narrower sides is lying on the receiving tray. In this example, sandwich pocket 53 is cut such to follow the contour of sandwich 52, while the open portion 5052 of sandwich 52 is located on the narrow side located in close proximity to the cutting knife, while the closed portion 5053 of sandwich 52 is located along the rest of the sandwich sides. However, sandwich 52 may be inserted into system 100 at the orientation of sandwich 54, such that the bread loaf is lying on one of the wider sides of the rectangle shaped sandwich 54. This orientation of sandwich 54 is positioned at a rotation of 90 degrees compared to the orientation of sandwich 52. In this case, the contour of sandwich pocket 55 is orientated at a rotation of 90 degrees compared to the contour of sandwich pocket 53. Furthermore, the open portion 5054 of sandwich 54 may be on located on the wide end located in close proximity to the cutting knife, whereas the closed portion 5055 may be located on substantially three other sides of the sandwich, along the margin of sandwich 54.

Similarly, sandwich 58 is oriented at 180 degrees compared to sandwich 60, thus the orientation of sandwich pockets 59 is oriented at 180 degrees compared to sandwich pocket 61, respectively. Accordingly, the open portion of each of these two sandwiches (e.g., open portion 5058 of sandwich 58, and open portion 5060 of sandwich 60) may be oriented at 180 degrees compared to one another, as do the closed portions of both sandwiches (e.g., closed portion 5059 of sandwich 58, and closed portion 5061 of sandwich 60). Additional shapes are illustrated by sandwich 50 and sandwich 56, though the bread loaf that may be loaded into system 100, and which may be cut into sandwiches comprising sandwich pockets may have many other shapes. Furthermore, it is noted that each sandwich may have a contour different from a previous or next sandwich in the same bread loaf.

In some embodiments, the contour of the sandwich pocket may be substantially similar to the cross section of the sandwich it is cut into. The cutting motion of the knife may be configured to follow alongside the outline of the bread loaf. That is, when the contour of the sandwich is round, the contour of the sandwich pocket will be created by configuring the knife to follow alongside the sandwich contour and the resulting pocket will also be round (e.g., sandwich 60 and respective sandwich pocket 61). When the contour of the sandwich is substantially square, the knife will be configured to cut along substantially square contour, such that the resulting contour of the sandwich pocket will also be substantially square (e.g., sandwich 52 and respective sandwich pocket 53). In other embodiments, the cutting knife is not necessarily configured to perform round movements at the entry and exit of the cutting knife into the sandwich, while cutting the pocket. Therefore, in such cases, the contour of the sandwich pocket may be straight at the entry and exit of the cutting knife into the sandwich while starting and ending the cutting process of the pocket, whereas along the cutting process in between the entry and exit of the knife from the sandwich, the contour of the sandwich pocket may be substantially similar to the contour of the sandwich's cross section (e.g., sandwich 56 and respective sandwich pocket 57).

Reference is now made to FIGS. 6A-6D, which schematically illustrate a front-side view, exploded perspective side view, a front view and a perspective side-view of a section of an exemplary measuring unit, according to an embodiment of the disclosure. As illustrated in FIG. 6A, measuring unit 500 may comprise a measuring ring 510, which may be rotated around a bread loaf, e.g., bread loaf 402 (FIG. 5A). Measuring ring 510 may be rotated around a bread loaf via timing belt 516, which may be turned by wheel 512 that may be operated by motor 550. Motor 550 may be located on the other side of measuring unit 500, opposite wheel 512. Measuring ring 510 may have attached thereon a distance sensor, e.g., sensor 520 (and sensor 521 illustrated in FIG. 5A) located on the inner side along the circumference of measuring ring 510. As explained above, distance sensor 520 may measure the distance between the inner side of the circumference of measuring ring 510 and the bread loaf. The angle from which the distance is measured, may be acquired by switch sensors, e.g., switch sensors 522 and 523 (FIG. 5A). As illustrated in FIG. 6B, measuring ring 510 may comprise teeth or indentation and protrusions 510a all along the outer side of its circumference. These indentations and protrusions 510a may correspond to the respective protrusions and indentations located along timing belt 516. Similarly, wheel 512 that may be connected to motor 550 and which may rotate measuring ring 510, may also comprise indentations and protrusions that correspond to the protrusions and indentations along timing belt 516.

Furthermore, measuring unit 500 may comprise a plurality of wheels, e.g. approximately six wheels 561, 562, 563, and 564 (two more are hidden behind measuring ring 510). These wheels may be configured to center measuring ring 510 with respect to frame 560 that measuring ring 510 is located within. Each of wheels 561, 562, 563, 564, etc. may hold measuring ring 510 at the same angle with respect to frame 560.

Reference is now made to FIG. 6C, which illustrates a front perspective view of the side of measuring unit 500, where motor 550 is located. This side is opposite the perspective side view illustrated in FIGS. 6A-6B. FIG. 6C illustrates all sensors; distance sensors 520 and 521, as well as switch sensors 522 and 523 with their respective flap 524. Each pair of sensors may be located at a distance of 180 degrees from one another, e.g., distance sensors 520 may be located at a distance of 180 degrees from distance sensor 521, and switch sensor 522 may be located at a distance of 180 degrees from switch sensor 523. As explained above, the distance of 180 degrees is ideal in order to enable a quicker acquisition of the outline measurements of the bread loaf, since more than one sensor located at a distance of 180 degrees to another sensor, enables acquisition of distance and angle measurements along half a turn of the measuring ring 510, instead of acquisition of distance and angle measurements along an entire cycle of measuring ring 510.

With respect to FIG. 6D, it is illustrated that measuring ring 510 may comprise several inner rings, e.g., rings 531, 532, 533 and 534, which may be separated from one another by respective separators 541, 542, 543 and 544. These inner rings may be located along the circumference of measuring ring 510, on the side opposite the side comprising indentations and protrusions which fit into the respective protrusions and indentations of timing belt 516 (FIG. 6A). —Separators 541, 542, 543 and 544 may be higher than the indentations serving as rings 531, 532, 533 and 534, in order to provide adequate separation between one ring to another. Each of rings 531, 532, 533 and 534 may be configured to carry an electrical wire of a different electrical component in measuring unit 500 in order to prevent such electrical wires from tangling within one another during rotation of measuring ring 510. For example, ring 531 may be configured to carry the electrical wire connecting between distance sensor 520 (FIG. 5A) to a power source (not shown), whereby the electrical wire may be wound around ring 531. In one example, ring 532 may be configured to carry the output electrical wire of distance sensor 520, whereby the electrical wire may be wound around ring 532. In one example, ring 533 may be used to carry the electrical wire connecting distance sensor 521 to a power source (not shown), whereby the electrical wire may be wound around ring 533. In one example, ring 534 may be configured to carry the output electrical wire of distance sensor 521, whereby the electrical wire may be wound around ring 534.

In one example, separator 541 may separate between ring 531 and ring 532. Separator 542 may separate between ring 532 and ring 533. Separator 543 may separate between ring 533 and ring 534, and separator 544 may separate between ring 544 and the edge of measuring ring 510.

In other embodiments, other numbers of inner rings, and thus other numbers of separators may be implemented, all according to the number of components located along the circumference of measuring ring 510 and which move and turn simultaneously with the turning motion of measuring ring 510.

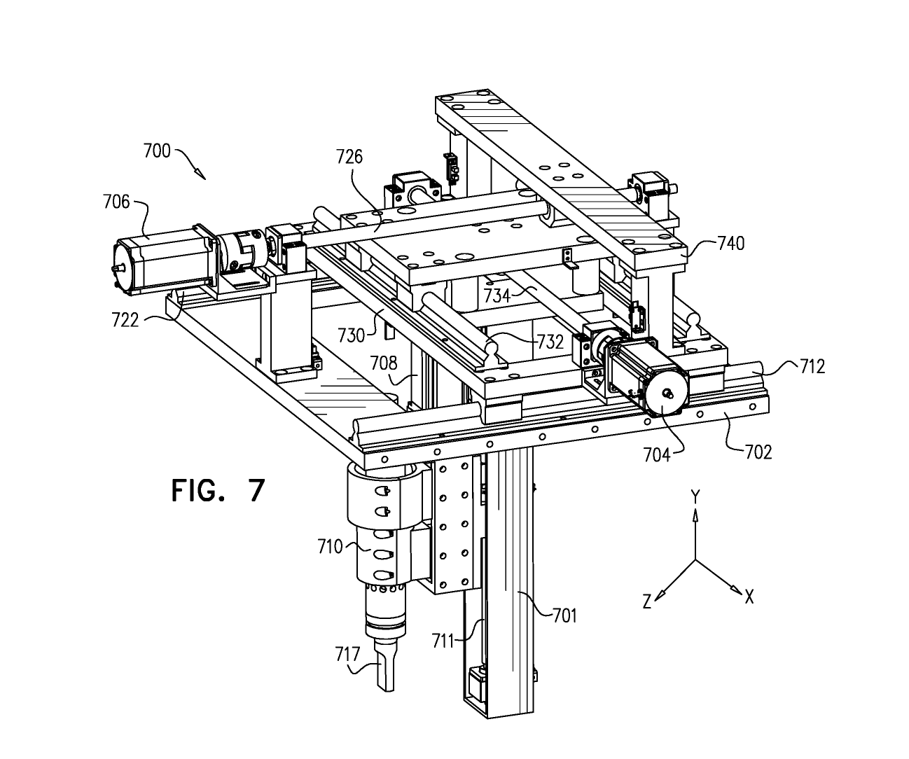

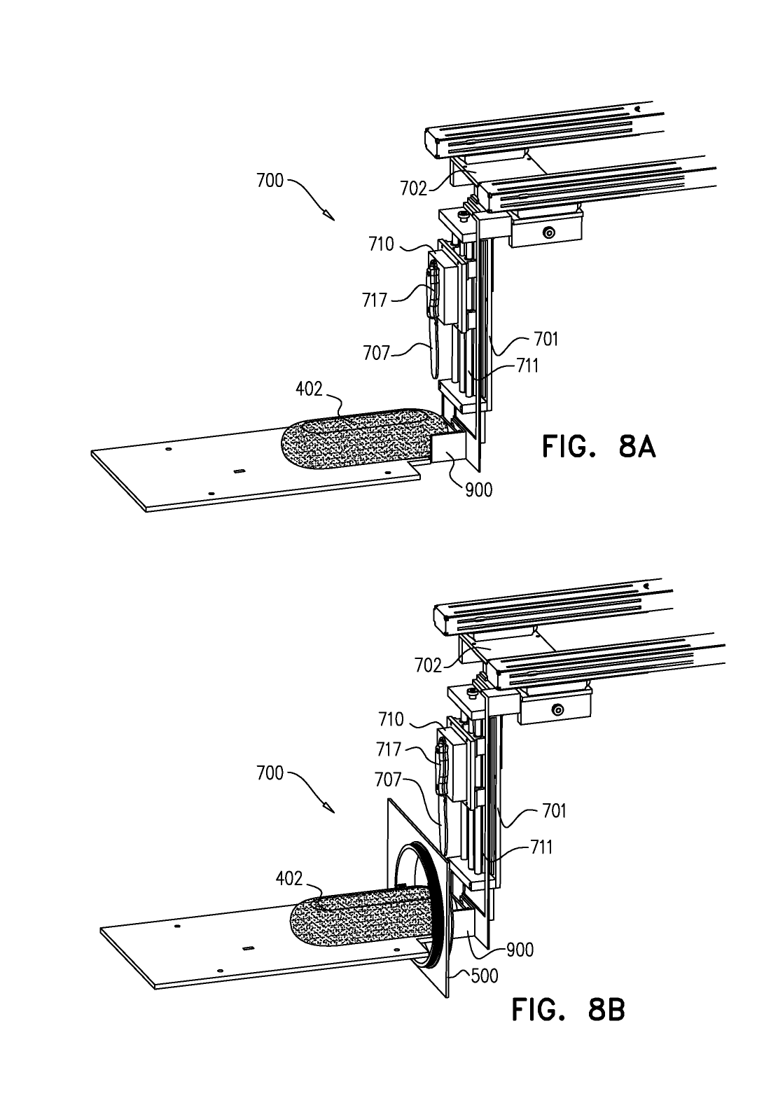

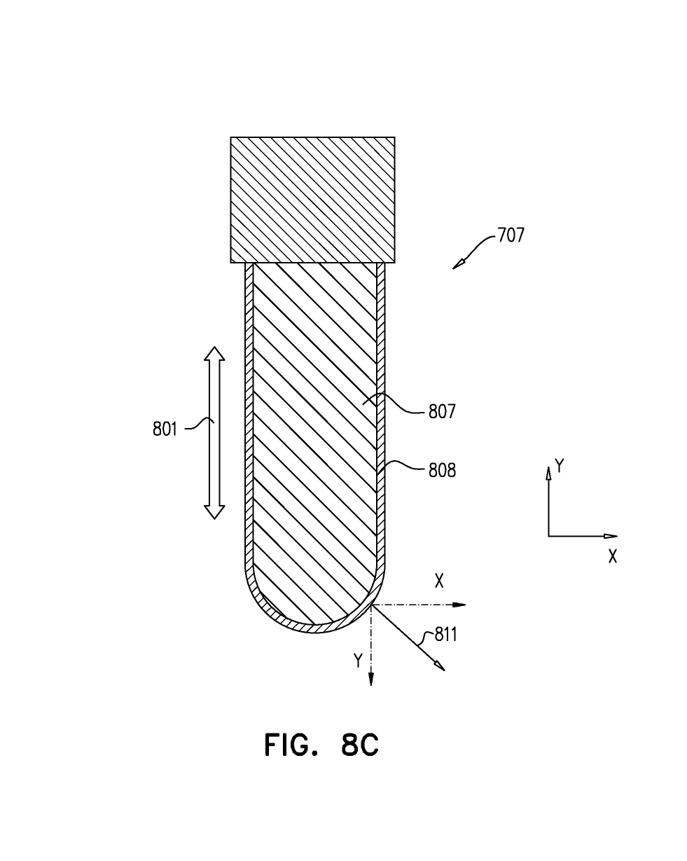

Reference is now made to FIG. 7, which is a schematic illustration of a cutting unit, according to an embodiment of the disclosure. Cutting unit 700 may comprise a base 702 which may be positioned along a plane defined by axes X and Z. Cutting unit 700 may further comprise a cutting arm 701, which may be positioned along axis Y, and may be connected to base 702. Therefore, cutting arm 701 may be located perpendicularly to base 702. Cutting arm 701 may be configured to hold the element that may be used to cut the pocket within the sandwich as well as to cut the sandwich off the bread loaf. Cutting arm 701 may comprise a rod 711 onto which section 710 may slide up and down, along axis Y, in order to raise or lower, respectively, extension 717, which is connected to the cutting element (e.g., cutting element 707, FIGS. 8A-8B). That is, the cutting element may be raised or lowered as part of the sandwich cutting process of a bread loaf.

In some embodiments, section 710 may be coupled to motor 708, which may operate the sliding motion of section 710 along rod 711. In some embodiments, there may be more than one rod 711, such to offer better stability to section 710 during its up and down sliding motion along such rods.

In some embodiments, base 702 of cutting unit 700 may further comprise rods 712 and 722 located along axis Z. In some embodiments, cutting arm 701 may move along rods 712 and 722. Base 702 may comprise a secondary base 730, which may be located on top of base 702 and parallel to base 702, whereby secondary base 730 may slide along rods 712 and 722 while being connected to arm 701, thus causing arm 701 to slide along rods 712 and 722. Rods 712 and 722 may be located along axis Z, and arm 701 may slide along these rods in either direction—forward or backwards along axis Z, as part of the sandwich cutting process of a bread loaf. The sliding of arm 701 along axis Z may be performed by a different motor than the one controlling sliding of section 710 along axis Y, e.g., movement of arm 701 may be operated by motor 706.

In some embodiments, secondary base 730 may have attached thereon rods 732 and 734, which may be configured to enable movement of cutting arm 701 in either direction along axis X. Element 740 that is also connected to cutting arm 701, may be configured to move cutting arm 701 along rods 732 and 734, which is equivalent to movement of arm 701 along axis X, as part of the sandwich cutting process of a bread loaf. The movement of arm 701 along axis X may be performed by a different motor than the one controlling movement along axis Y or Z, e.g., movement of arm 701 may be operated by motor 704.

Movement of cutting arm 701 along axis X may be performed when cutting a pocket or cutting the sandwich from one side of the bread loaf to the other opposite side. Movement of cutting arm 701 along axis Z may be performed when there is, a need to locate the cutting arm at the correct location along axis Z prior to beginning of the cutting process of a pocket, and then to relocate arm 701 along axis Z (e.g., move arm 701 backwards, i.e., further away from the cut edge of the bread loaf and towards the uncut end of the bread loaf) prior to cutting the sandwich off the bread loaf. Movement along axis Y of section 710 of arm 701 may be performed during the cutting process of the pocket within the sandwich and of the sandwich off the bread loaf, in order to adjust the depth of the cut into the bread loaf, along axis Y.

In some embodiments, each of the above mentioned rods that operate movement of cutting arm 701 along the three axes X, Y and Z, may have attached on both ends of each rod an optical switch sensor (not shown). These optical switch sensors may enable calibration of operation of cutting unit 700, every time that system 100 is turned on. The distance between the optical switch sensors is known, and the steps taken by arm 701 along each of the rods may then be translated into distance (for example, distance measured in [mm]). In addition, these optical switch sensors may provide safety by determining when the rod has reached the end of its path. If a controller that may be coupled to each of the engines of each of the three axes of the cutting unit, sends a command to arm 701 to move to a location that is past the end of the path of a certain rod, then the central control unit may send a command to stop operation of the engine controlling motion of that certain rod, once the end of the path of a rod is sensed by the respective optical switch sensor positioned on that certain rod.

Reference is now made to FIGS. 8A-8C, which schematically illustrate a front-side view of a cutting unit that is part of the system for cutting a bread loaf into sandwiches with pockets, a front-side view of the cutting and measuring units, and a knife for cutting a bread loaf into sandwiches, respectively, according to an embodiment of the disclosure. FIGS. 8A and 8B illustrate cutting unit 700 comprising the cutting element 707, e.g., a cutting knife that cuts the bread loaf. According to some embodiments, knife 707 may be attached to extension 717, which may be connected to section 710. As described with respect to FIG. 7, section 710 may move, e.g., slide, along rod 711, which may be attached to cutting arm 701. That is, section 710 of cutting arm 701, along with cutting knife 707 may be moved along axis Y, e.g., may be raised above a bread loaf or lowered towards the bread loaf that is to be cut by cutting knife 707.

FIG. 8A illustrates cutting unit 700 alone, whereas FIG. 8B illustrates cutting unit 700 along with measuring unit 500, as implemented in system 100. Measuring unit 500 may be located in close proximity to cutting unit 700, such that the outline of bread loaf 402 may first be measured by measuring unit 500 in order to determine the size of the pocket and sandwich that is to be cut by cutting unit 700. A control unit may receive the measurements measured by measuring unit 500, and process them into the appropriate size of pocket and sandwich that is to be cut by cutting unit 700, and further send instructions to cutting unit 700, based on such processing.

In some embodiments, knife 707 may be a standard metal knife, with a smooth blade or a serrated blade. In other embodiments, knife 707 may be made of plastic or any other solid material.

According to some embodiments, knife 707 may be configured to vibrate along an axis that is perpendicular to the axis along which the bread loaf is being cut. For example, as illustrated in FIG. 7, cutting arm 701 is located parallel to plane XY, that is, the bread loaf is being cut in parallel to plane XY; first along axis Y, when knife 707 enters into the bread loaf and cuts down through it along axis Y, and then along axis X, when knife 707 moves along the width of the bread loaf, whether for cutting a sandwich pocket or for cutting the sandwich off the bread loaf. Therefore, when knife 707 moves along axis Y, knife 707 may be configured to vibrate along axis X, which is perpendicular to axis Y, in order to effectively cut the bread loaf. In some embodiments, knife 707 may further be configured to vibrate along axis Y, for even better cutting efficiency and effectiveness, when knife 707 moves along axis X.

Knife 707 may vibrate in ultrasonic, subsonic, or any combination thereof. In the subsonic vibrations, the amplitude of knife 707 may be e.g., around 2-5 mm, with a frequency of e.g., 500-1000 Hz.

In some embodiments, knife 707 may be an ultrasonic knife that uses ultrasonic vibrations in order to make a smooth cut. Knife 707 may vibrate along an axis that is perpendicular to the axis along which the bread loaf is being cut. For example, if knife 707 cuts the bread loaf along axis Y then knife 707 may vibrate along a perpendicular axis, e.g., axis X in ultrasonic vibrations. And if knife 707 cuts the bread loaf along both axis Y and axis X, as explained above, knife 707 may vibrate along both, axis X and axis Y, respectively, in ultrasonic vibrations. Knife 707 may be, for example, an ultrasonic knife model MC-5020L manufactured by MECS (Mechanism Electronic Control Service), though any other ultrasonic knife may be implemented as part of cutting unit 700. An ultrasonic generator (not shown) sends an ultrasound high power signal through a transducer, which converts the signal into a mechanical vibration comprising a very small amplitude (e.g., as small as 20 μm) with high power (e.g., 500W). In some embodiments, the ultrasonic generator may send vibrations to knife 707 at a frequency range beyond the human hearing, e.g., above 20 kHz. Ultrasonic knives have high precision and make clean cuts with little waste (e.g., a small amount of bread crumbs accumulate during cutting of the bread loaf with an ultrasonic knife) compared to standard knives, thus making ultrasonic knives a preferable option to be implemented as part of the cutting unit 700.

According to FIG. 8C, knife 707 may comprise a main body 807 and a rounded blade 808. In some embodiments, if knife 707 cuts the bread loaf along axis X, then knife 707 may be configured to vibrate along an axis that is perpendicular to axis X along which knife 707 moves, e.g., knife 707 may vibrate along axis Y. Due to the rounded shape of blade 808, although knife 707 is configured to vibrate only along axis Y, the rounded ends of blade 808 may provide an angled cut, that is, the rounded ends of blade 808 may move along vectors that comprise a component in the direction of the X axis, as well as a component in the direction of the Y axis. For example, blade 808 may move along vector 811, which may comprise a component in the direction of axis X as well as a component in the direction of axis Y.

Therefore, even though knife 707 is configured to vibrate along axis Y alone, the rounded blade 808 may vibrate along axis X in addition to vibrating along axis Y. This may be advantageous when the bread loaf is to be cut along both axis Y and axis X. Thus, instead of causing knife 707 to vibrate along both axis X and axis Y, knife 707 may vibrate along axis Y only, while vibrations along axis X are inherent at the rounded ends of blade 808, due to the shape of knife 707, which comprises rounded blade 808.

In some embodiments, in addition to subsonic vibrations or ultrasonic vibrations, knife 707 may be configured to perform “fast-cutting” vibrations. In the “fast-cutting” vibrations, the amplitude of knife 707 may be e.g., 10 mm, with a frequency of e.g., 1 Hz up to 300 Hz. These type of vibrations may significantly improve the effectiveness of the subsonic and/or ultrasonic vibrations. Typically, knife 707 may be configured to vibrate according to the “fast-cutting” vibrations along an axis that is perpendicular to the axis along which the bread loaf is being cut. For example, when knife 707 is cutting the bread loaf along axis Y, then knife 707 may include “fast-cutting” vibrations along axis X, in addition to the subsonic vibrations and/or ultrasonic vibrations along axis X.

In some embodiments, during cutting of a sandwich and its respective sandwich pocket by the cutting unit, e.g., cutting unit 700, a new sandwich may be measured by the measuring unit, e.g., measuring unit 500. That is, measuring unit may measure the outline of the bread loaf in order to determine the width of the next sandwich, as well as the contour of its respective sandwich pocket during cutting of a previous sandwich pocket or during cutting of a previous sandwich off the bread loaf.

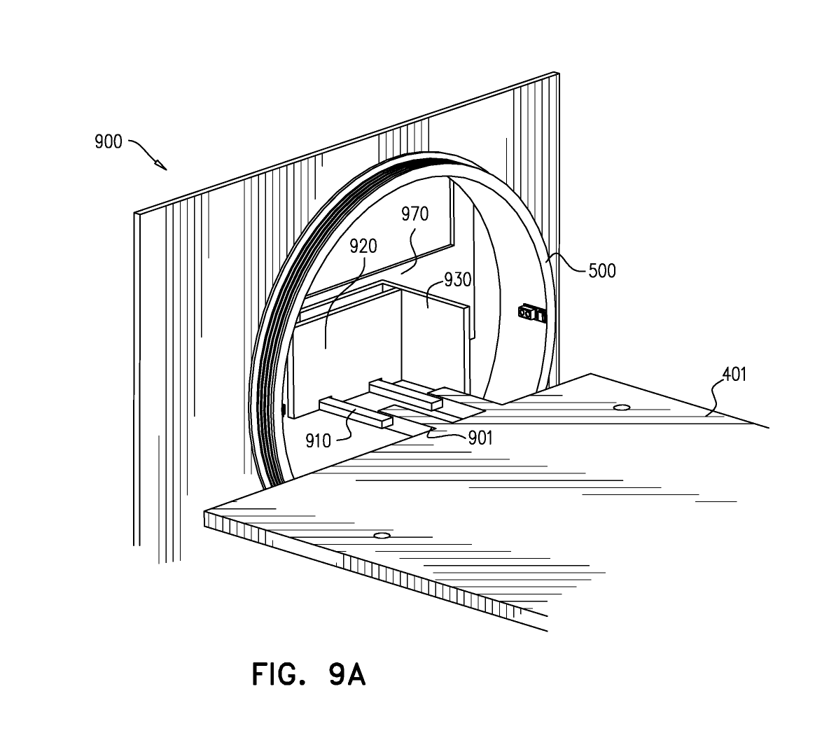

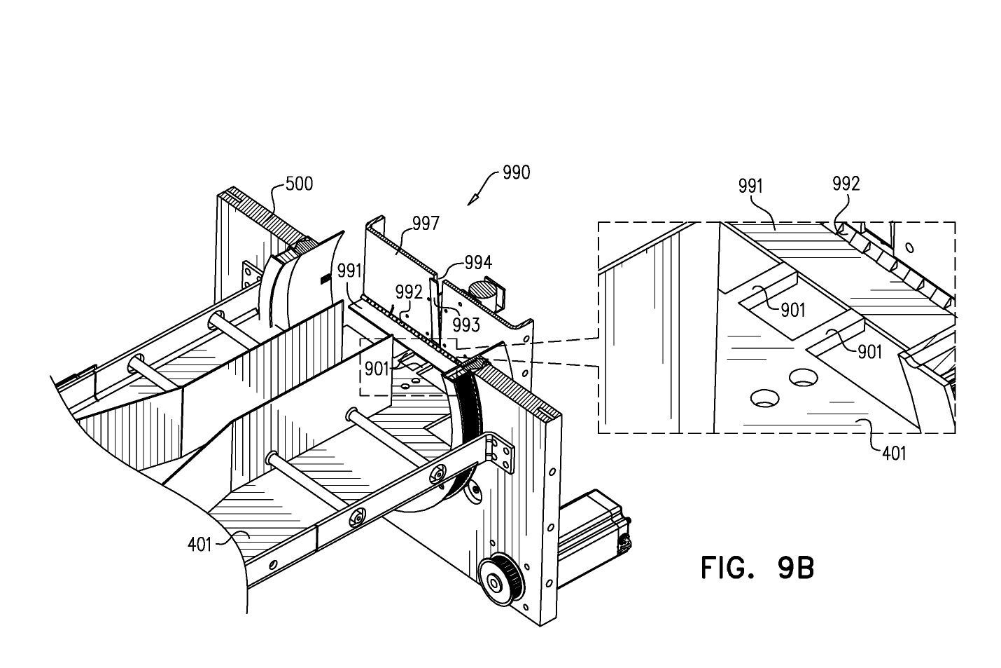

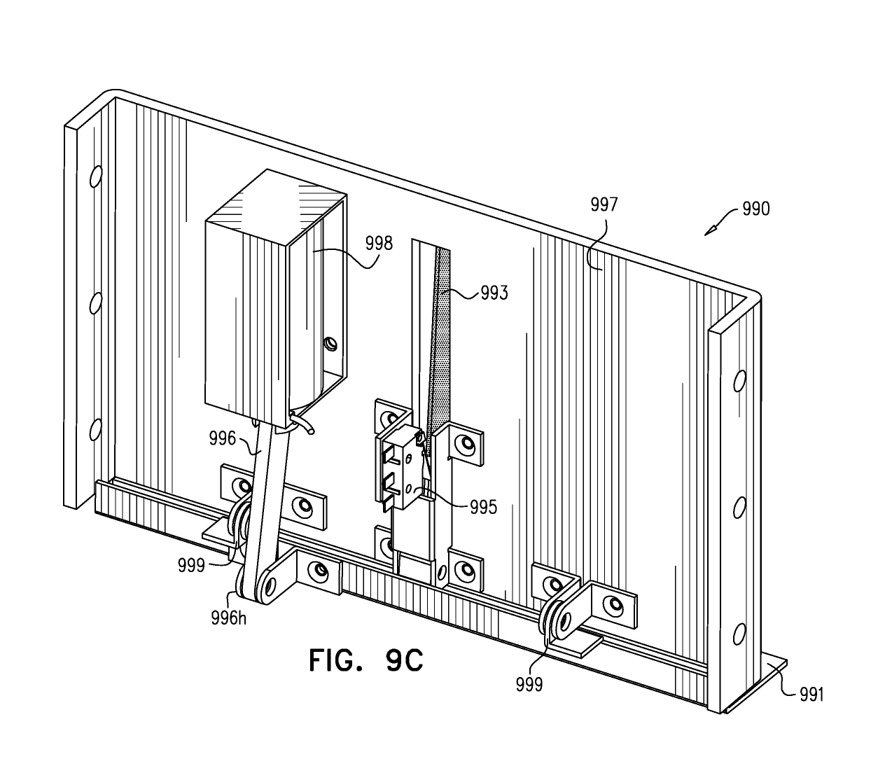

Reference is now made to FIG. 9A, which is a schematic top-side view of the arms that hold the bread loaf during its cutting, according to an embodiment of the disclosure. Unit 900 may comprise the arms or forks that are configured to hold the bread loaf while it is being cut, and which are to be separated when the cutting of the pocket and sandwich are done, such to enable the cut sandwich to fall and continue its way towards the next unit of system 100.

In some embodiments, unit 900 may comprise arms or fork 901, which may be an extension or may be connected to tray 401. Across arms 901, there may be arms or fork 910, which may be connected to wall 920. Wall 920 may be configured to support the edge of the bread loaf, e.g., the sandwich that is being cut by cutting unit 700. Wall 920 may be located perpendicularly to arms 910, and thus perpendicularly to the longitudinal axis of the bread loaf being cut, and parallel to the plane defined by the sandwich being cut off the bread loaf. Unit 900 may further comprise element 930. One section of element 930 may be located behind wall 920, while another part of element 930 may be perpendicular to wall 920. The part of element 930 which is perpendicular to wall 920 may be configured to support the side of the bread loaf, e.g., to support the bread loaf with respect to its longitudinal axis. In some embodiment, element 970 may be located behind element 930, and may be connected to arm 701 of cutting unit 700.

In some embodiments, when cutting unit 700 cuts through the bread loaf, fork 901 is located across fork 910 such that the teeth or arms of fork 901 are located in close proximity to the arms or teeth of fork 910. When the arms of fork 901 are close and even touch the arms of fork 910, fork 901 and fork 910 provide support to the bread loaf and specifically to the part of the bread loaf that is being cut by cutting unit 700. After cutting the pocket within the sandwich and following completion of cutting the sandwich off the bread loaf, fork 910 may be moved away from fork 901, thus creating space between fork 901 and fork 910. The space created between fork 901 and fork 910 may be configured to be large enough such to enable passage of the cut sandwich therethrough. Control of the movement of fork 910 away from fork 901, may be controlled by a control unit (not shown). In order for fork 910 to move away from fork 901, such to enable the cut sandwich to continue its journey along system 100, e.g., to a packaging unit, elements 930 and 970 should also move away from fork 901. Therefore, the control unit is to control movement of arm 701 away from tray 401 (FIG. 8B) following completion of the cutting process, thus enabling element 930 to move away from tray 401 and away from fork 901, and further enabling fork 910 to move away from fork 901 and further away from tray 401.

Reference is now made to FIGS. 9B-9C, which schematically illustrate a perspective view, and a back-side view of the door that holds the bread loaf during its cutting process and which opens after the cutting process is accomplished, according to an embodiment of the disclosure. As described with respect to FIG. 9A, tray 401 may have attached arms or fork 901, which may be configured to hold and support the bread loaf. Opposite arms or fork 901 may be positioned unit 990, which may assist in holding and supporting the bread loaf during its cutting process. Unit 990 may comprise a wall 997, which may be positioned perpendicularly to fork 901. Wall. 997 may further comprise door 991, which may have attached teeth 992. When in its closed position such to provide support to a bread loaf, door 991 may be positioned perpendicularly to wall 997, which his equivalent to door 991 being perpendicular to fork 901. When door 991 is in its open position such to enable a cut sandwich to continue towards the packaging process, door 991 may no longer be positioned perpendicularly to wall 997 but may rather be located at an angle with respect to wall 997. In other embodiments, when in open position, door 991 may open such to be substantially parallel to wall 997, or even be located on the same plane as wall 997.

In some embodiments, both door 991 and teeth 992 may support the edge of the bread loaf being cut, e.g., the plane of the sandwich that is parallel to wall 997. The edge of the bread loaf may rest on or be pushed onto door 991 and teeth 992, while door 991 and teeth 992 may support the bread loaf from the bottom side of the bread loaf. Teeth 992 may be positioned at an angle with respect to the horizontal plane of door 991, therefore enabling the cut sandwich to slide from door 991 more easily, off teeth 992 and into the packaging unit, once door 991 is open.

In some embodiments, unit 990 may further comprise a flap 993, which may be pass through wall 997 and may be connected to a micro-switch 995 (FIG. 9C). Flap 993 may be pushed back when a bread loaf is pressed against wall 997 and thus against flap 993, via the loading unit, e.g., loading unit 300 or loading unit 400. Once flap 993 is pushed back, micro switch 995 may sense such movement, and correlate it with presence of the bread loaf onto door 991. Micro switch 995 may be connected to a central control unit of system 100, or it may be coupled to an internal control unit, e.g., control unit 998. Either of these types of control units may receive indication of presence of a bread loaf onto door 991, and may further send a command to a cutting unit, e.g., cutting unit 700, to cut a pocket into the bread loaf as well as to cut a sandwich off the bread loaf that is positioned on door 991. Control unit 998 may be wirelessly connected to micro switch 995 and to cutting unit 700. Following the cutting process, door 991 may be operated to change position to its open position, such to enable the cut sandwich to slide and fall towards the next unit in system 100, e.g., the packaging unit.

As can be seen in FIG. 9C, micro switch 995 may be connected to flap 993 such to receive information on presence of a bread loaf onto door 991, via movement of flap 993 that may be caused when a bread loaf is pushed against flap 993. In some embodiments, control unit 998 may also be connected to a motor, which may operate door 991 and may cause it to change positions from its closed position (when a bread loaf is placed onto it) to its open position (when a sandwich is to slide off door 991 and enter the next unit along system 100), and vice versa. Control and motor units 998 may move arm 996, or more specifically hinge 996h which is located at one end of arm 996. Arm 996 may be connected to door 991 via hinge 996h on one of its ends, while being connected to wall 997 on its other end. When control and motor 998 causes hinge 996h to move e.g., rotate, it in fact causes door 991 to move and switch between its open and closed positions.

In some embodiments, door 991 may be connected to wall 997 through arm 996 via hinge 996h. In other embodiments, door 991 may be further connected to wall 997 through additional supports such as hinges 999, in order to provide better stability in the connection between door 991 and wall 997. If door 991 is held by more than one hinges and/or arms, then door 991 is connected to wall 997 in a more stable and solid manner.

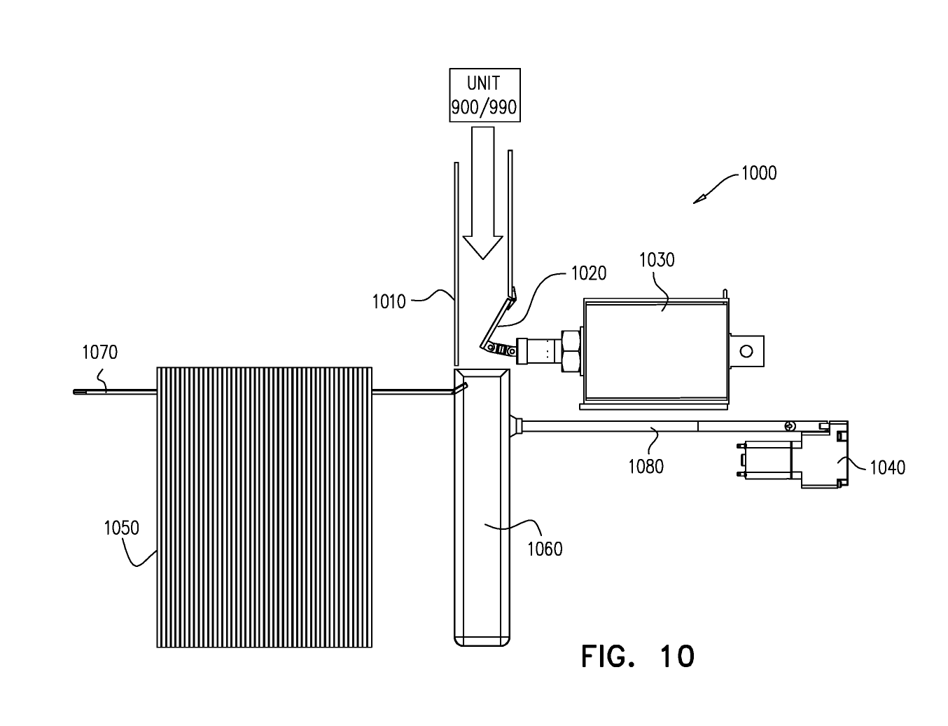

Reference is now made to FIG. 10 which is a schematic illustration of a packaging unit for packaging a cut sandwich, which is part of the system for cutting a bread loaf into sandwiches with pockets, according to an embodiment of the disclosure. In some embodiments, once fork 910 moves away from fork 901, space is created, which is large enough for the cut sandwich to pass through. The sandwich may then enter the packaging unit 1000 via sandwich guide 1010. Sandwich guide 1010 may be configured to guide the sandwich into a sandwich bag. Sandwich guide 1010 may comprise a guide door 1020 in the shape of a bendable leg, which may be configured to either be in a straight ‘open’ position, thus allowing the sandwich to enter into its package or bag 1060, or may be in a bent ‘closed’ position, thus preventing the sandwich from entering its respective sandwich bag 1060. Packaging unit 1000 may further comprise an actuator 1030, which may actuate and control changing the positions of the sandwich guide from ‘open’ to ‘close’ and vice versa. When a sandwich is being cut, the sandwich guide is actuated by actuator 1030 to remain in its ‘closed’ position. However, when the sandwich is fully cut by cutting unit 700, the actuator 1030 actuates the sandwich guide to open, thus allowing the cut sandwich to fall into its sandwich bag, e.g., sandwich bag 1060.

In some embodiments, while a sandwich is being cut by cutting unit 700, one sandwich bag, e.g., bag 1060, is sucked by air pump 1040 via suction tube 1080, from the sandwich bag cartridge 1050, which may be hung on rod 1070. Sandwich bag 1060 is sucked by vacuum pressure by pump 1040 towards pump 1040, thereby being separated from the rest of the bags attached to the sandwich bag cartridge 1050. Pump 1040 keeps its high negative pressure such that the sandwich bag 1060 is kept open, “waiting” for a sandwich to enter into it. Once a sandwich is cut, the actuator 1030 operates the sandwich guide 1010 to open, thus changing the configuration of guide door 1020 from bent position, i.e., closed position, to its straight position, i.e., open position, and the sandwich slides or falls into sandwich bag 1060.

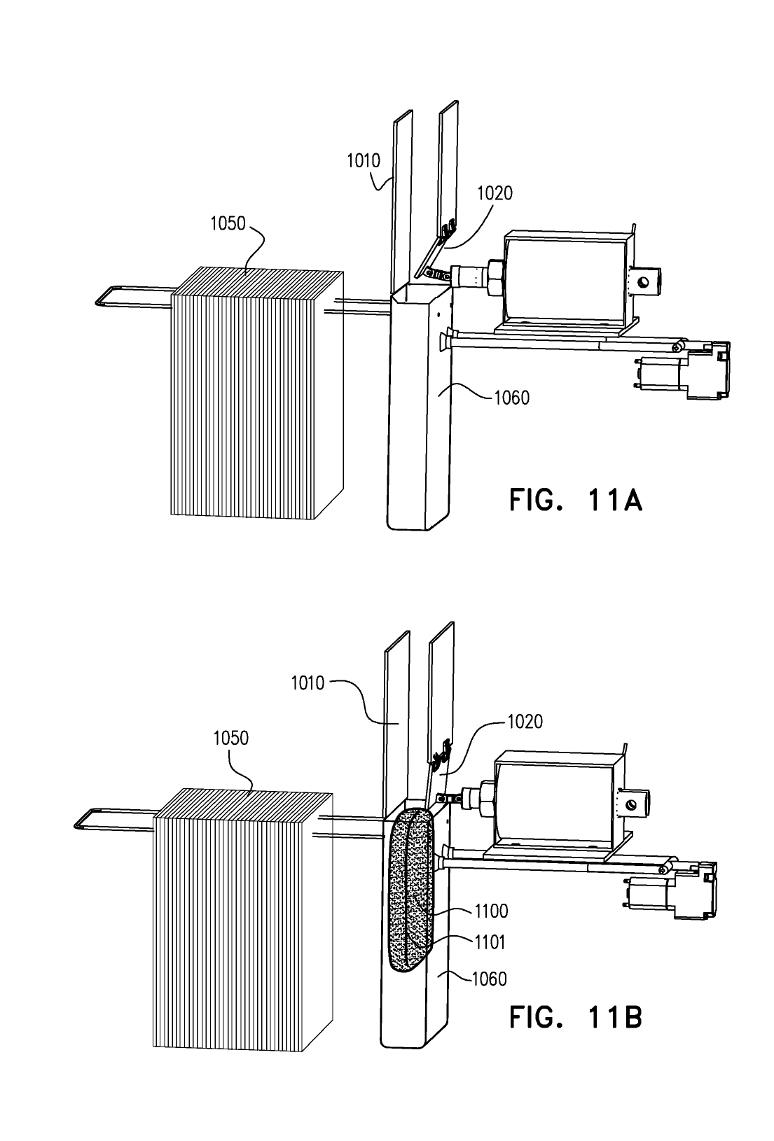

Reference is now made to FIGS. 11A-11B, which are schematic illustrations of the sandwich bag and guide door after the bag is open but the guide door is still closed, and after the guide door is open such to insert the sandwich into the bag, according to an embodiment of the disclosure. FIG. 11A illustrates guide door 1020 in its closed position, prior to entry of a sandwich into the vacuumed sandwich bag 1060 via guide 1010. FIG. 11B illustrates guide door 1020 in its open position, following entry of a cut sandwich into guide 1010, such to enable the cut sandwich to enter its individual sandwich bag 1060. When guide door 1020 is open, the cut sandwich, e.g., sandwich 1100, which comprises sandwich pocket 1101, may easily slide or fall into already open sandwich bag 1060.

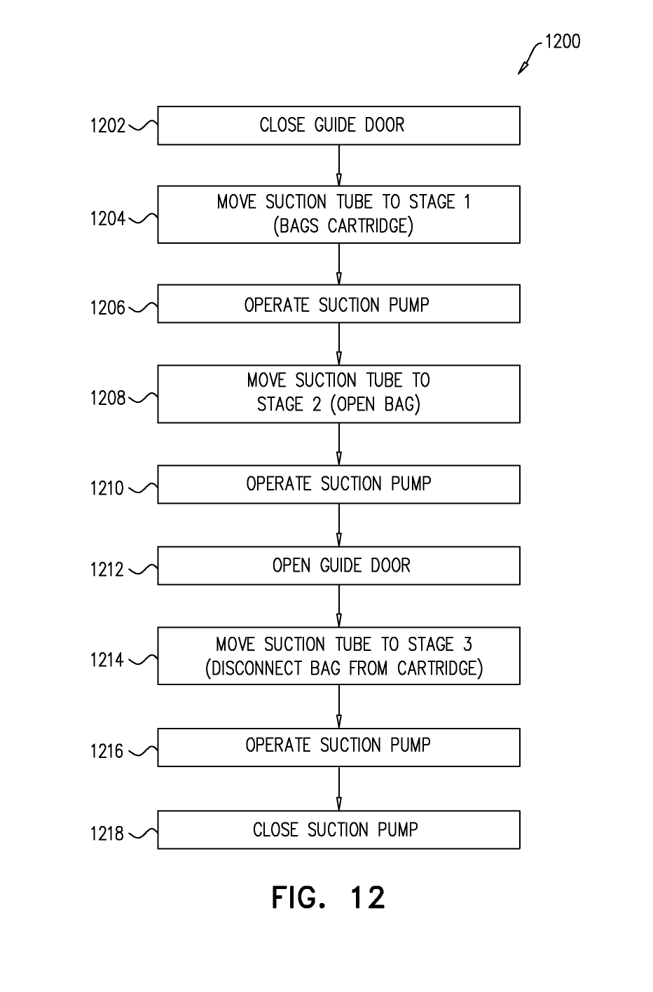

Reference is now made to FIG. 12, which is a flow chart of operations performed by the packaging unit, according to an embodiment of the disclosure. Flow chart 1200 may comprise the steps performed by packaging unit 1000. The first step 1202 may comprise the guide door 1020 (FIG. 10) being in closed configuration. Then in step 1204, the suction tube 1080 (FIG. 10), which is connected to pump 1040, may be moved to stage 1, which is moving towards the sandwich bags cartridge 1050. In step 1206, the suction pump 1040 is operated in order to attach sandwich bag 1060 to suction tube 1080. Then step 1208 comprising operating suction tube 1080 at stage 2 begins, which is equivalent to starting opening of the sandwich bag 1060. When suction pump 1040 is operated in step 1210, the sandwich bag attached to suction tube 1080 begins to open. In step 1212, guide door 1020 opens, to enable entry of the cut sandwich into the open sandwich bag 1060. Suction tube 1080 is then moved to stage 3 during step 1214, which is equivalent to detaching the sandwich bag from the sandwich bag cartridge 1050. Suction pump 1040 is then operated in step 1216, causing the sandwich bag 1060 to disconnect itself from the sandwich bag cartridge 1050, such to provide an individual package per the cut sandwich. Suction pump 1040 is then closed in step 1218, awaiting cutting of a new sandwich, which means the packaging process will begin all over again, in step 1202.

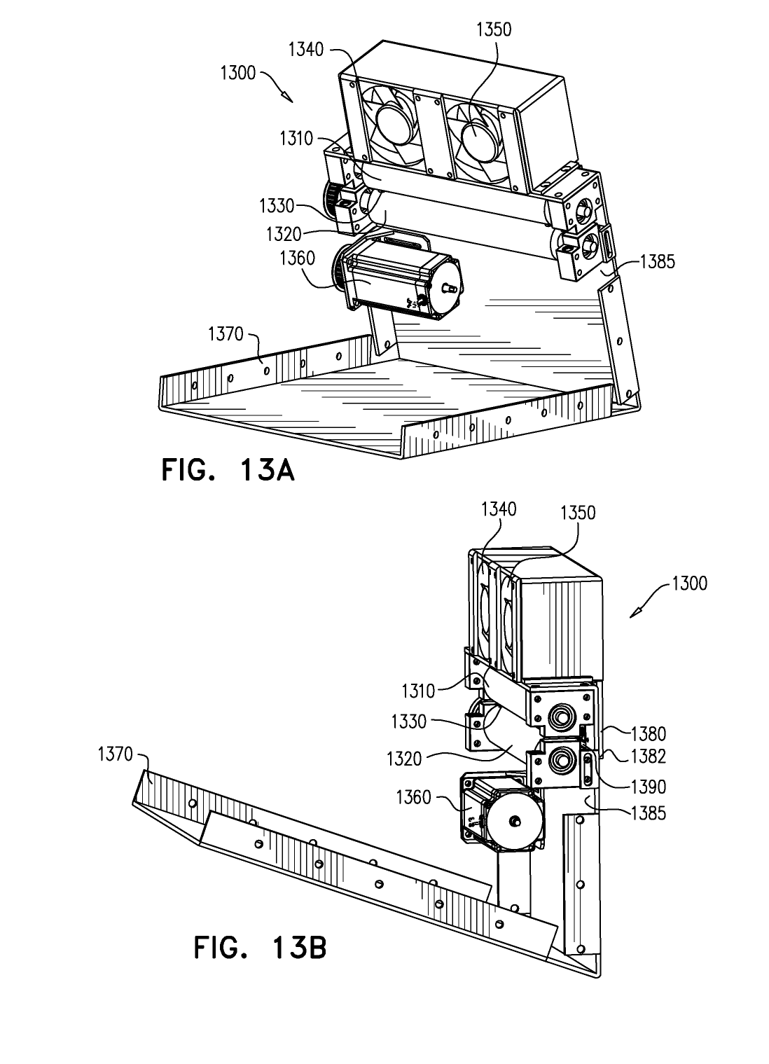

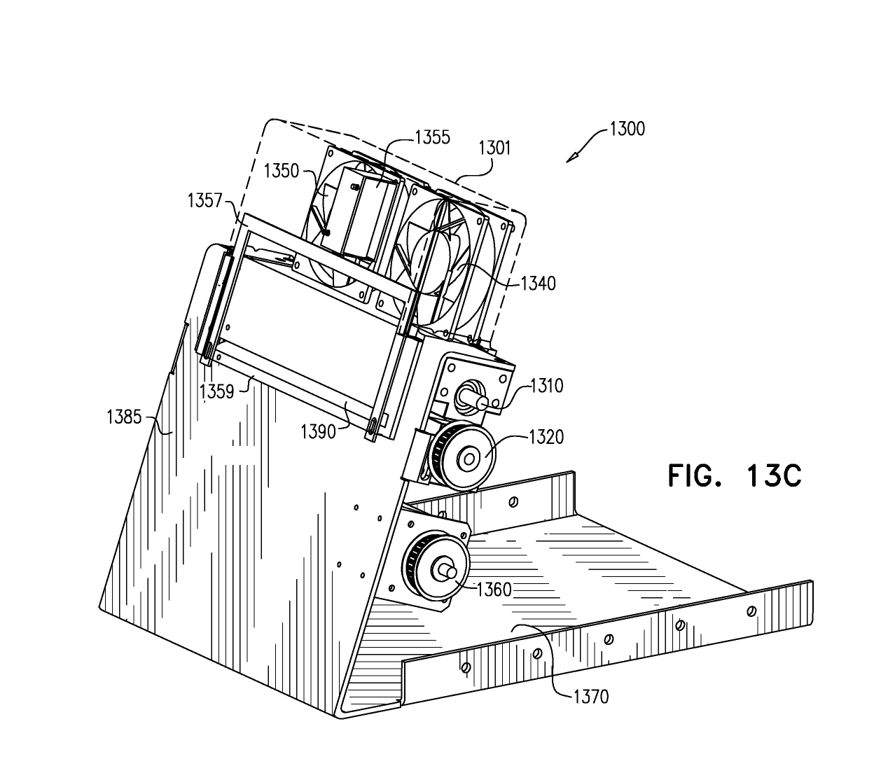

Reference is now made to 13A-13C which are schematic illustrations of a back-side view, a perspective side view, and a front-side view, respectively, of a packaging unit for packaging a cut sandwich, according to another embodiment of the disclosure. Sandwich packaging unit 1300 illustrates an example of a sandwich packaging unit in addition to unit 1000. Packaging unit 1300 may comprise a cartridge of sandwich bags (not shown), which may be positioned on tray 1370. The sandwich bags' cartridge may comprise sandwich bags that are connected to each other only, on one side of the opening end of each bag (e.g., by perforation). That is, if air would be blown onto the first bag that is attached to the cartridge, the bag would open, while still being attached to the rest of the bags of the cartridge. The first bag of the cartridge may be loaded in between two rollers; roller 1310 and roller 1320, in the opening 1330 therebetween. Roller 1310 and roller 1320 may be attached to wall 1385. As illustrated in FIG. 13B, on the other side of wall 1385, the sandwich bag that enters through opening 1330 may exit through bag exit 1390. Packaging unit 1300 may further comprise fan 1340 and fan 1350, which may blow air into a bag that passed through bag exit 1390. In some embodiments, air from fan 1340 and from fan 1350 may be configured to pass through space 1380, which may be an extension to fans 1340 and 1350 in close proximity to wall 1385, and the air may exit through an air exit 1382, which may be located at least partially above bag exit 1390, which one sandwich bag may pass through. Once a bag passes through bag exit 1390, air may be blown by operation of fans 1340 and 1350 such to fill the sandwich bag with air flowing through air exit 1382, which is located above the sandwich bag's opening. The flow of air into the sandwich bag's opening may assist in maintaining the sandwich bag open and ready for entrance of a cut sandwich into it.

In some embodiments, packaging unit 1300 may further comprise a distance sensor 1395 that may be located on wall 1385, as illustrated in FIG. 13C. Distance sensor 1395 may sense presence of a sandwich bag and may sense when the bag is ready to accept a cut sandwich, since the sensing occurs on the side of wall 1385 where air exit 1382 is located.

In some embodiments, after the sandwich bag is filled with a sandwich that includes a sandwich pocket, the sandwich bag is to be cut and be separated from the sandwich bags' cartridge, so that a new sandwich bag may pass through bag exit 1390 in order to accept a new sandwich, and so on. In order to cut the sandwich bag off the cartridge, packaging unit 1300 may comprise a cutting knife 1359. As illustrated in FIG. 13C, cutting knife 1359 may be connected to solenoid 1355 via member 1357. A sandwich bag may pass through bag exit 1390 such that one side of the open end of the sandwich bag may be attached to the cartridge of sandwich bags, e.g., by perforation, while the other side of the open end of the sandwich bag may not be attached to the cartridge, thus allowing air from fans 1340 and 1350 to blow the sandwich bag open, such that the open end of the sandwich bag may be positioned below bag exit 1390.

Once a sandwich enters the blown open sandwich bag, member 1357 may be pulled up towards the location of fans 1340 and 1350 by solenoid 1355. Cutting knife 1379 is attached to member 1357, for example, cutting knife 1359 may be located between the two ends of member 1357. Therefore, once member 1357 is pulled up by solenoid 1355 then cutting knife 1359 may be pulled against the sandwich bag, at the location where the sandwich bag is attached to the sandwich bags' cartridge, thus cutting the area of attachment between the single sandwich bag and the sandwich bags' cartridge. In some embodiments, distance sensor 1395 may be configured to stop the turning of rollers 1310 and 1320 once the sandwich bag is detected by distance sensor 1395, such that the area of attachment between the single sandwich bag and the sandwich bags' cartridge may be located in front of bag exit 1390. This is important so that once solenoid 1355 pulls up cutting knife 1359 (via member 1357), the area of attachment would be cut by cutting knife 1359 passing through the area of attachment.

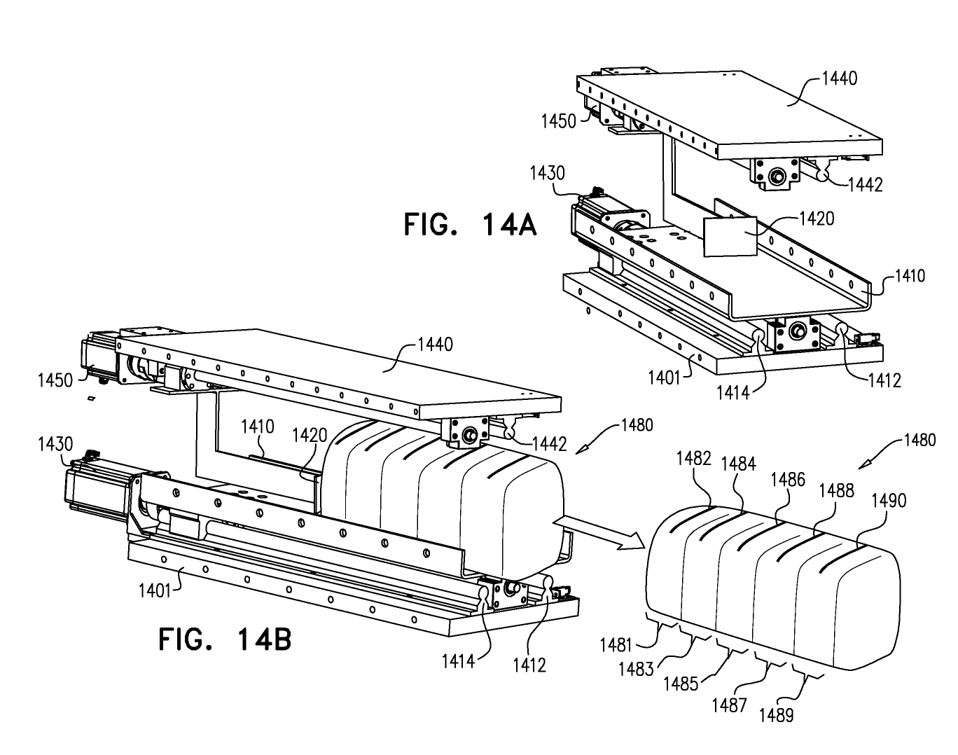

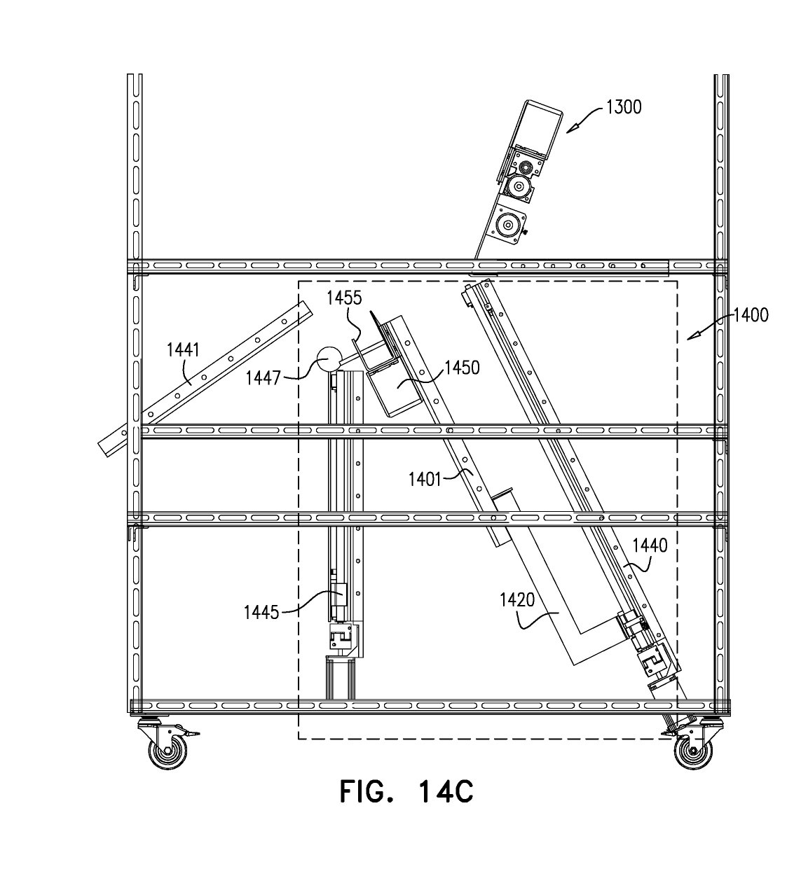

Reference is now made to FIGS. 14A-14B, which schematically illustrate a bread loaf packaging tray, according to an embodiment of the disclosure. Packaging tray 1410 may be configured to accept all of the cut sandwiches, whether separately packaged or not. Each cut sandwich, e.g., each of sandwiches 1481, 1483, 1485, 1487 and 1489, may fall either off the cutting unit (if not separately packaged) or off the sandwich packaging unit (if separately packaged), onto tray 1410. All of the cut sandwiches may be arranged to form the entire bread loaf 1480, which is the bread loaf that was cut into sandwiches, e.g., sandwiches 1481, 1483, 1485, 1487, and 1489, and their respective sandwich pockets, e.g., sandwich pockets 1482, 1484, 1486, 1488, and 1490. The order of sandwiches that is to form a whole bread loaf 1480 may be accomplished by causing the sandwiches to fall onto tray 1410 in a certain direction, typically front to back, such that the front end of each sandwich touches the back end of a previous sandwich. The arranged sandwiches may then be placed in one large package, for ease of carrying by the user.

In some embodiments, the first sandwich that falls onto tray 1410 lands on driver 1420 such that the front portion of the first sandwich is supported by driver 1420, while the bottom end (which is perpendicular to the front portion) of the first sandwich is supported by tray 1410. Each of the rest of the sandwiches fall onto previous sandwiches, while all of the sandwiches are supported by driver 1420 from their front end (or cross section), while being supported from their bottom end by tray 1410. Driver 1420 may move backwards along tray 1410 each time a new sandwich falls onto try 1410, in order to provide space along tray 1410 for a new sandwich to fall onto. When all the sandwiches are accumulated onto tray 1410 and onto driver 1420, tray 1410 may be pushed into a large package that is configured to fit the entire sandwiches. Driver 1420 may then provide the final push such that all of the cut sandwiches enter, the large package while tray 1410 is pulled back to exit the large package, such that only the sandwiches are kept inside the one large package.

In some embodiments, tray 1410 may move along rods 1412 and 1414, which may be positioned on base 1401. As explained above, tray 1410 may be pushed forward into the package or may be pulled back to exit the package, all of which movement may be accomplished by sliding back and forth along rods 1412 and 1414. Motor 1430 may be connected to tray 1410 such to provide power for such motion of tray 1410 along rods 1412 and 1414.

In some embodiments, driver 1420 may be connected to base 1440 via rod 1442, such that driver 1420 may slide along rod 1442 on both directions, e.g., backward and forward. Motor 1450 may provide power to such motion of driver 1420 along rod 1442.

Reference is now made to FIG. 14C, which schematically illustrate the entire bread loaf packaging unit 1400, according to an embodiment of the disclosure, which some of it was illustrated in FIGS. 14A-14B as described above. In some embodiments, following the separately packaging of each single sandwich as performed by packaging unit 1300 (FIGS. 13A-13C), all the separate packages accumulate along tray 1401, while being supported by driver 1420 from their bottom side. Driver 1420 is configured to retract when a new sandwich drops onto it. After all the bread loaf is cut into sandwiches, and measuring unit (e.g., measuring unit 500, FIGS. 6A-6D) detects no object, i.e., bread within it, then a bread loaf sized sandwich bag may be opened in order to accept all the cut sandwiches into it. In order to open a new bread loaf sized sandwich bag, at least one fan 1450 may blow air into such bag. However, in some embodiments, the brad loaf sized bag may be too heavy to open simply by blowing air into it. Therefore, assistance may be acquired by motion of handle 1447. In some embodiments, handle 1447 may comprise a round shape, though in other embodiments handle 1447 may comprise other shapes. Handle 1447 may be pushed by arm 1445 such to provide support to the bag being blown with air from at least one fan 1450. Handle 1447 may support the bread loaf bag by supporting it and straightening it with respect to the outlet 1455 of air from fan 1450. When handle 1447 supports and straightens the bread loaf bag, the air blown by at least one fan 1450 may suffice to fill the entire bread loaf bag, which now properly faces outlet 1455, with air. Driver 1420 may then push the bread loaf (comprising sandwiches, whether or not separately packaged) into the open air filled bread loaf bag. The force of the push of driver 1420 may, in some embodiments, be strong enough such to tear the bread loaf bag off the bread loaf bags' cartridge, once all the sandwiches entered the bread loaf bag. Immediately following entry of all sandwiches into the bread loaf bag and tear of the bag from its cartridge, the entire packaged bread loaf drops on top of tray 1441, due to gravity forces. The packaged bread loaf continues to slide on top of tray 1441 until it exits system 100, ready to be collected by a customer or user of system 100.

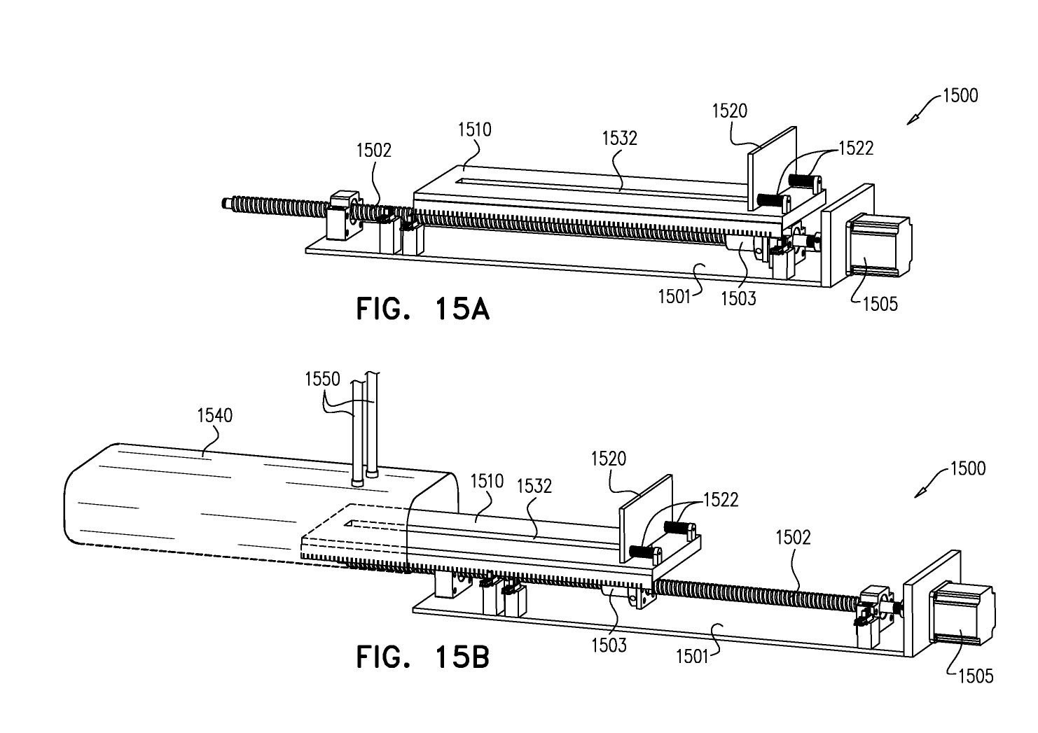

Reference is now made to FIGS. 15A-15B, which schematically illustrate a bread loaf packaging tray, according to another embodiment of the disclosure. Packaging tray 1510 may be configured to accept all cut sandwiches whether separately packaged or not. Each cut sandwich may fall either off the cutting unit (if not separately packaged) or off the sandwich packaging unit (if separately packaged), onto tray 1510. All of the cut sandwiches may be arranged along tray 1510 to form the entire bread loaf, which is the bread loaf that was cut into sandwiches and sandwich pockets.

In some embodiments, tray 1510 may comprise a driver 1520, which may move along tray 1510 via a tunnel 1532. Tray 1510 may be connected to a base 1501 via nut 1503 that may be screwed/unscrewed along longitudinal screw 1502. The motion of nut 1503 along screw 1502 may be operated by motor 1505. When nut 1503 is screwed forward along screw 1502, then tray 1510 is moved forward towards package or bag 1540 (FIG. 15B). When nut 1503 is unscrewed backwards, then tray 1510 is moved backwards away from package 1540.

As illustrated in FIG. 15B, a large package 1540 that is to fit all cut sandwiches, which form the entire bread loaf, may be opened by various means, e.g., suction via suction tubes 1550, or through air blown by fans (not shown). Other means of opening package or bag 1540 may be used. Once package 1540 is opened, tray 1510, which may be loaded with the entirely cut bread loaf, may be pushed forward by motion of nut 1503 forward along screw 1502, such to place the bread loaf that is cut into sandwiches with sandwich pockets, into bag 1540. Driver 1520 may then be operated by springs 1522 to move forward towards bag 1540, and continue to push the cut brad loaf into bag 1540. Once the entire cut sandwiches are inserted into package 1540, tray 1510 may be pulled back by backward motion of nut 1503 along screw 1502, in order to allow tray 1510 to exit from within package 1540, and thus leave only the bread loaf cut into sandwiches with sandwich pockets, to stay within package 1540.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the disclosure. Further combinations of the above features are also considered to be within the scope of some embodiments of the disclosure. It will also be appreciated by persons skilled in the art that the present disclosure is not limited to what has been particularly shown and described hereinabove.

I/We claim:

1. A method for cutting a bread loaf into sandwiches, each sandwich comprising two partially connected slices of bread with a sandwich pocket there between, said method comprising:
inserting the bread loaf into a system for cutting sandwiches comprising sandwich pockets;
measuring the outline of the bread loaf;
determining the width of a sandwich and the contour of its respective sandwich pocket based on the measured outline of the bread loaf;
cutting the sandwich pocket, according to the determined sandwich pocket contour; and
cutting the sandwich off the bread loaf, according to the determined width.

2. The method according to claim 1, further comprising packaging all the cut sandwiches in one package.

3. The method according to claim 1, further comprising packaging each cut sandwich in a separate package.

4. The method according to claim 3, further comprising packaging all the separately packaged sandwiches into one package.

5. The method according to claim 1, wherein inserting the bread loaf into said system is performed by loading the bread loaf onto a conveyer.

6. The method according to claim 1, wherein measuring the outline of the bread loaf in order to determine the width of the next sandwich, and the contour of its respective sandwich pocket is performed following every cut of a sandwich.

7. The method according to claim 1, wherein measuring the outline of the bread loaf in order to determine the width of the next sandwich, and the contour of its respective sandwich pocket is performed during cutting of the previous sandwich pocket or during cutting of the previous sandwich off the bread loaf.

8. The method according to claim 1, further comprising exiting the cut sandwiches out of said system.

9. The method according to claim 1, wherein the width of the sandwich is determined by a user per user's preferences.

10. The method according to claim 1, wherein an optimal pocket contour is determined to be closest to the sandwich outline.

11. A system for cutting a bread loaf into sandwiches, each sandwich comprising two partially connected slices of bread with a sandwich pocket there between, said system comprising:
a loading unit for loading the bread loaf into the system;
a measuring unit for measuring an outline of the bread loaf;
a processor for determining a contour of a sandwich pocket; and
a cutting unit for cutting a sandwich pocket according to the determined contour, and for cutting its respective sandwich off the bread loaf.

12. The system according to claim 11, wherein said loading unit is a conveyer.

13. The system according to claim 11, wherein the processor is configured to receive user preferences comprising a sandwich width according to which the cutting unit cuts the bread loaf.

14. The system according to claim 11, further comprising a packaging unit for packaging all cut sandwiches in one package.

15. The system according to claim 11, further comprising a packaging unit for separately packaging each cut sandwich.

16. The system according to claim 15, wherein said packaging unit packages all separately packaged sandwiched in one package.

17. The system according to claim 11, wherein an optimal pocket contour is determined by the processor to be closest to the sandwich outline.

18. The system according to claim 11, wherein the measuring unit measures the outline of the bread loaf in order to determine the width of the next sandwich, and the contour of its respective sandwich pocket during cutting of the previous pocket or during cutting of the previous sandwich off the bread loaf.

19. The system according to claim 11, further comprising an exit through which the cut sandwiches exit the system.
